(19) United States
(12) Patent Application Publication
(10) Pub. No.: US 2025/0357657 A1
(43) Pub. Date: Nov. 20, 2025

(54) Motion Control Apparatus and Systems for Non-Stationary Monitoring and/or Directional Pointing Systems such as Radar Systems

(71) Applicants: BATTELLE MEMORIAL INSTITUTE, Richland, WA (US); United States Geological Survey, Reston, VA (US)

(72) Inventors: Christopher R. Rumple, Port Angeles, WA (US); Alex M. Turpin, Edmonds, WA (US); Emma D. Cotter, Milwaukee, WI (US); Robert H. Diehl, Bozeman, MT (US)

(73) Assignees: BATTELLE MEMORIAL INSTITUTE, Richland, WA (US); United States Geological Survey, Reston, VA (US)

(21) Appl. No.: 19/209,284

(22) Filed: May 15, 2025

Related U.S. Application Data
(60) Provisional application No. 63/648,027, filed on May 15, 2024.

(51) Int. Cl. H01Q 1/18; F16M 11/10; F16M 11/20; G01S 7/02; H01Q 1/34; H04N 23/695

(52) U.S. Cl. CPC H01Q 1/18; F16M 11/10; F16M 11/2014; G01S 7/027; H01Q 1/34; H04N 23/695

(57) ABSTRACT

Embodiments provide systems for reorientation of a beam pointers, receivers (or detectors when supported by reorientable components), and/or antennas for remote object monitoring systems, (e.g., detector systems or interrogation systems) such as for example radar antenna orientation systems, that use a mechanical leverage system in the form of a slider-crank mechanism that pivotally couples a receiver, and/or antenna to a face-mount crossed-roller bearing that in turn is coupled to one or more linear actuators, where the combination provides for both pitch and yaw motion of the beam point, receiver, or antenna relative to a base with linear motion of an actuator providing pitch orientation of the beam pointer, receiver, or antenna while not moving heavy system components which instead are rotationally coupled to beam pointer, the receiver, or antenna to reduce linear and rotational inertia of the moving pointer, receiver, or antenna.

### RELATED APPLICATIONS

This application claims benefit of U.S. Patent Application No. 63/648,027 filed May 15, 2024. This referenced application is hereby incorporated herein by reference in its entirety.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

### Field of the Invention

Embodiments of invention generally relates to orienting beam pointing systems and/or distant object monitoring systems (e.g., where objects are potentially as close as tens to hundreds of meters or as far as tens of kilometers to perhaps one hundred kilometers or more). In some embodiments, the systems may be exposure systems, detection systems, or a combination thereof (i.e., interrogator systems such as radar systems that transmit signals and detect return response signals); more particularly, embodiments of the invention relate to rapid motion control of such beam pointing and/or monitoring systems where the systems may be supported by movable bases that are subject to displacement, rotational, and/or rocking motions such as might occur when the bases are floating on a body of water and where it is intended that a desired correspondence of changing target directions and actual pointing/monitoring directions be maintained. In some embodiments, monitoring is intended to track relatively small flying objects such as birds and bats.

### Background Information

In the United States, offshore wind energy is being developed, planned, or considered on the Atlantic and Pacific coasts, in the Gulf of Mexico, and in the Great Lakes. Offshore wind facilities may pose collision hazards for birds and bats or stimulate behavioral changes, such as avoidance or attraction in response to wind turbines. Detecting and monitoring flying animals in the vicinity of prospective wind farms is necessary to help scientists and regulators evaluate potential effects on vertebrate populations and to inform decisions concerning mitigation measures.

Baseline data on bird populations offshore have previously been collected with vessel or aerial surveys, but more information about flight behavior and abundance at wind development sites can be gained by deploying continuously-operating remote sensors. However, collecting baseline data from remote sensors in open water is challenging, and as a result the distribution of birds and bats over open water is poorly understood. A key technical challenge is that most existing monitoring technologies, like radar, require deployment from a stable platforms for a given scanning strategy. If the position of the radar antenna is known, data can be used to assess the altitude that animals are flying at and their range from the radar. However, if the antenna is rocking back and forth due to platform motion, the altitude measurement will be less accurate. In addition to the requirement for motion compensation, radar data collection offshore is further complicated by the requirement that equipment must be marinized to survive in an offshore environment and operate continuously with limited availability of electrical power and opportunities for maintenance.

Regardless of the target intended, beam type to be pointed (if any), detection to be made (if any), a need exists for improved beam pointing and/or monitoring systems (e.g., radar systems, laser beam pointing systems, IR monitoring systems such as thermal camera systems, and acoustic listening systems) that can accurately and stably point at, scan, or monitor targets (e.g., interrogate or detect) while being deployed on unstable platforms and particularly when deployed on floating platforms.

### SUMMARY

It is an object of some embodiments of the invention to provide an improved pointing system and monitoring system with rapid reorientation capability for directing a beam in a given direction and/or detecting signals coming from the given direction.

It is an object of some embodiments of the invention to provide an improved monitoring system (e.g., a radar system) with a configuration of components and functionality that provide for reduced inertia of rotating and/or pitching components.

It is an object of some embodiments of the invention to provide a crank and slider mechanism to control pitch using the slider and crank mechanism providing for pitch control of a beam pointer and/or of a directional detection system where pitch or elevation movement and control may be about an axis that is perpendicular to an azimuthal axis about which a signal receiver, reorientable detector, or antenna rotate or oscillate.

Some embodiments provide apparatus or systems for reorienting beam pointers, signal receivers (or reorientable detectors), and/or antenna for remote object monitoring systems, (e.g., detection systems or interrogation systems) such as for example radar antenna orientation systems, that use a mechanical leverage system in the form of a slider-crank mechanism that pivotally couples a receive or antenna to a face-mount crossed-roller bearing that in turn is coupled to one or more linear actuators, where the combination provides for both pitch and yaw motion of the receiver or antenna pointing direction relative to a base with linear motion of an actuator providing pitch orientation of the receiver or antenna while not moving heavy system components which instead are rotationally coupled to the receiver antenna to reduce linear and rotational inertia of the moving antenna. Some embodiments also provide for orientation of the antenna, beam pointer, or receiver toward any point in the sky and stabilization of the orientation against external motion (e.g., motion that might result from the antenna being incorporated onto a floating buoy or other moving base) while allowing a receiver or antenna to sweep the sky along a defined path relative to fixed inertial coordinates using rapid pitch variations and and/or changes in azimuthal sweeping rates to provide the required compensation based on processed GPS, IMU, gyroscope, and/or other sensor data such that precise scanning strategies to compensate for a moving platform are enabled.

In some embodiments, the radar interrogation system may be replaced by a different interrogator, pointing system, or detection system. For example UV, IR, or visible beam emitter may be located on a support structure that is reorientable (e.g. rotatable about a azimuthal axis and tiltable about an elevational axis) relative to a system base while a source of the UV, IR, or visible radiation may be located in a fixed position relative to the base wherein a fiber optic or transmission conduit may run along the azimuthal axis for feeding the radiation to an emitter wherein the transmission path may include one or more rotatable fiber optic couplers. In some embodiments, the source may be a laser. In some embodiments, incoming optical or acoustic signals may be picked up by one more detectors supported by the reorientable support structure or alternatively the reorientable support structure may include focusing optics, reflectors, and/or wave guides that direct signals to detectors located in fixed locations relative to a system base. In some detector systems or integration systems spectral information may be gathered and analyzed.

In a first aspect of the invention, an apparatus for supporting and moving a radar antenna, includes: (a) a base; (b) a radar antenna; (c) a radar antenna support structure attached, directly or indirectly, to the base; (d) a rotatable shaft extending, directly or indirectly from the support structure along an azimuthal axis around which the radar antenna can rotate wherein the azimuthal axis has a fixed orientation with respect to the base, and wherein the azimuthal axis has a variable orientation with respect to a zenith, due at least in part, to rocking movement that the base can undergo when the apparatus is in use; (e) at least one crank arm fixedly connected, directly or indirectly, to the radar antenna wherein the at least one crank arm extends, directly or indirectly, away from a rear of the antenna, includes at least one tilt axis engagement feature, wherein the tilt axis is, directly or indirectly, supported by the shaft and extends perpendicular to the azimuthal axis and allows pitch movement, and further includes at least one connector arm engagement feature; (f) a connector arm joining, directly or indirectly, the at least one connector arm engagement feature in a manner that allows rotational motion between the at least one connector arm and the at least one crank arm wherein the rotational motion occurs about an axis that is parallel to the tilt axis; (g) a first slide structure capable of translational movement along the azimuthal axis, wherein the slide structure connects, directly or indirectly, to a lower end of the at least one connector arm in a manner that allows rotation of the at least one connector arm such that translation of the slide structure causes motion of the at least one connector arm, the at least one crank arm, and tilting of radar antenna; (h) a second slide structure capable of translational movement along the azimuthal axis; (i) a bearing having first and second mounting features that can be rotated relative to each other about the azimuthal axis wherein the first mounting feature is fixedly, directly or indirectly, connected to the first slide structure and wherein the second mounting feature is fixedly, directly or indirectly, connected to the second slide structure; (j) at least one linear actuator having a moving end joined, directly or indirectly, to the second slide structure for translating the first and second slide structures along the azimuthal axis such that translational movement of the slide structures cause tilting of the antenna about the tilt axis while still allowing rotational motion of the antenna and first slide structure about the azimuthal axis relative to the second slide structure; (k) a rotational actuator for rotating the shaft such that the antenna is capable of rotary motion about the azimuthal axes; and (l) at least one controller for controlling the actuators to provide rotation of the antenna about the azimuthal axis and tilting of the antenna about the tilt axis.

Numerous variations of the first aspect of the invention exist and include, for example: (1) the bearing including a face-mount crossed roller bearing; (2) the first aspect or the first variation thereof wherein the base includes a buoyant structure that floats on a body of water; (3) the second variation of the first aspect wherein the buoyant structure has an effective area defining a horizontal surface area contact with the water of greater than 10 square meters; (4) the third variation of the first aspect wherein the effective area is selected from the group consisting of: (i) at least 20 square meters, (ii) at least 50 square meters, (iii) at least 200 square meters, and (iv) at least 500 square meters; (5) the first aspect or the first variation thereof wherein the base is mounted, directly or indirectly, to buoyant structure including a floating buoy or platform; (6) the fifth variation of the first aspect wherein the buoyant structure has an effective area defining a horizontal surface area contact with the water of greater than 10 square meters; (7) the sixth variation of the first aspect wherein the effective area is selected from the group consisting of: (i) at least 20 square meters, (ii) at least 50 square meters, (iii) at least 200 square meters, and (iv) at least 500 square meters; (8) the first aspect or the first variation thereof wherein the base is supported by a boat or ship floating on a body of water; (9) the first aspect or the first variation wherein the boat or ship has a water displacement selected from the group consisting of (i) at least 2 tons but less than 20 tons, (ii) at least 20 tons but less than 200 tons, and (iii) at least 200 tons but less than about 2000 tons; and (10) the first aspect or any of the first to ninth variations thereof wherein the at least one linear actuator includes at least two linear actuators.

Numerous additional variations of the first aspect of the invention exist and include, for example: (11) the tenth variation of the first aspect wherein the at least two linear actuators include at least three linear actuators; (12) the eleventh variation of the first aspect wherein the at least three linear actuators include at least four linear actuators; (13) the first aspect or any of the first-twelfth variations thereof wherein the at least one linear actuator is selected from the group consisting of (i) a variable position magnetically-driven linear actuator, (ii) a hydraulic actuator, and (iii) a screw-driven linear actuator; (14) the first aspect or any of the first-thirteen variations thereof wherein the at least one linear actuator is configured to allow unresisted linear motion when not actuated and made to move to hold a commanded position when actuated; (15) the first aspect or any of the first-fourteenth variations thereof wherein the at least one linear actuator can provide an acceleration of moving components at an amount selected from the group consisting of: (i) greater than 2 m/s². (ii) greater than 5 m/s², (iii) greater than 10 m/s², (iv) greater than 20 m/s²; (16) the first aspect or any of the first-fifteenth variations thereof wherein the at least one crank arm includes at least two crank arms; (17) the first aspect or any of the first-sixteenth variations thereof wherein the at least one connector arm includes at least two connector arms; (18) the first aspect or any of the first-seventeenth variations thereof wherein the at least one rotational actuator is selected from the group consisting of: (i) a servo motor, (ii) a stepper motor, (iii) a direct drive motor; (19) the first aspect or any of the first-eighteenth variations thereof wherein the antenna includes a dish antenna; (20) the first aspect or any of the first-nineteenth variations thereof wherein the antenna is covered by a protective dome; and. (21) the first aspect or any of the first-twentieth variations thereof additionally including one or more sensors selected from the group consisting of: (i) one or more encoders, (ii) one or more incoders, (iii) one or more GPS sensors with Euler angles, (iv) one or more GPS sensors without Euler angles, (v) one or more magnetic compass direction sensors, (vi) one or more gravitational datum sensors, (vii) one or more IMUs, and (viii) one or more gyroscopes wherein the one or more sensors are configured to provide position or angular orientation information of one or more system components.

In a second aspect of the invention, a movement and stabilization system for supporting a radar antenna mounted, directly or indirectly, to a base that is subject to angular oscillation or rocking about two perpendicular axes that are each perpendicular to a vertical axis pointing to a zenith around which rotation is to occur, includes: (a) a base; (b) a radar antenna; (c) a radar antenna support structure attached, directly or indirectly, to the base; (d) a rotatable shaft extending, directly or indirectly from the support structure along an azimuthal axis around which the radar antenna can rotate wherein the azimuthal axis has a fixed orientation with respect to the base, and wherein the azimuthal axis has a variable orientation with respect to a zenith, due at least in part, to rocking movement that the base can undergo when the apparatus is in use; (e) at least one crank arm fixedly connected, directly or indirectly, to the radar antenna wherein the at least one crank arm extends, directly or indirectly, away from a rear of the antenna, includes at least one tilt axis engagement feature, wherein the tilt axis is, directly or indirectly, supported by the shaft and extends perpendicular to the azimuthal axis and allows pitch movement, and further includes at least one connector arm engagement feature; (f) a connector arm joining, directly or indirectly, the at least one connector arm engagement feature in a manner that allows rotational motion between the at least one connector arm and the at least one crank arm wherein the rotational motion occurs about an axis that is parallel to the tilt axis; (g) a first slide structure capable of translational movement along the azimuthal axis, wherein the slide structure connects, directly or indirectly, to a lower end of the at least one connector arm in a manner that allows rotation of the at least one connector arm such that translation of the slide structure causes motion of the at least one connector arm, the at least one crank arm, and tilting of radar antenna; (h) a second slide structure capable of translational movement along the azimuthal axis; (i) a bearing having first and second mounting features that can be rotated relative to each other about the azimuthal axis wherein the first mounting feature is fixedly, directly or indirectly, connected to the first slide structure and wherein the second mounting feature is fixedly, directly or directly, connected to the second slide structure; (j) at least one linear actuator having a moving end joined, directly or indirectly, to the second slide structure for translating the first and second slide structures along the azimuthal axis such that translational movement of the slide structures cause tilting of the antenna about the tilt axis while still allowing rotational motion of the antenna and first slide structure about the azimuthal axis relative to the second slide structure; (k) a rotational actuator for rotating the shaft such that the antenna is capable of rotary motion about the azimuthal axes; and (l) at least one controller for rotating the antenna about the azimuthal axis and to tilt the antenna about the tilt axis such that any rocking of the base is compensated for such that rotation about the azimuthal axis and tiling of the antenna about the tilt axis provide a sweeping radar beam with an angle of motion that is a selected angle of motion with a variation that is less than a variation of an angle of motion of the base.

Numerous variations of the second aspect of the invention exist and include, for example: (1) the roller bearing including a face-mount crossed roller bearing; (2) the second aspect or the first variation thereof wherein the selected angle of motion can be varied upon command; (3) the second aspect or the first or second variation thereof wherein the variation in the angle of motion includes an angle of motion selected from the group consisting of: (i) less than ¼ that of the base, (ii) less than ⅛ that of the base, (iii) less than 1/16 that of the base, (iv) less than 1/32 that of the base; (4) the second aspect or the first or second variation thereof wherein the variation in the angle of motion is selected from the group consisting of: (i) less than 4° degrees, (ii) less than 2°, (iii) less than 1°, and (iv) less than ½°; (5) the second aspect or the first or second variation thereof wherein the variation in the angle of motion is selected from the group consisting of: (i) smaller than 4° of positioning error when the a base motion orients the shaft at no more than 15° from vertical and a targeting direction is within an operational range of antenna orientation, (ii) smaller than 2° of positioning error when a base motion orients the shaft at no more than 15° from vertical and a targeting direction is within an operational range of antenna orientation, (iii) smaller than 1° of positioning error when the when a base motion orients the shaft at no more than 15° from vertical and a targeting direction is within an operational range of antenna orientation, (iv) smaller than ½° of positioning error when a base motion orients the shaft at no more than 15° from vertical and the targeting direction is within an operational range of antenna orientation. (v) smaller than 4° of positioning error when the a base motion orients the shaft at no more than 30° from vertical and a targeting direction is within an operational range of antenna orientation, (vi) smaller than 2° of positioning error when the a base motion orients the shaft at no more than 30° from vertical and a targeting direction is within an operational range of antenna orientation, (vii) smaller than 1° of positioning error when the a base motion orients the shaft at no more than 30° from vertical and a targeting direction is within an operational range of antenna orientation, and (ix) smaller than ½° of positioning error when the a base motion orients the shaft at no more than 30° from vertical and a targeting direction is within an operational range of antenna orientation; (6) the second aspect or the first variation thereof wherein the base includes a buoyant structure that floats on a body of water; (7) the sixth variation of the second aspect wherein the buoyant structure has an effective area defining horizontal surface area contact with the water of greater than 10 square meters; (8) the seventh variation of the second aspect wherein the effective area is selected from the group consisting of: (i) at least 20 square meters, (ii) at least 50 square meters, (iii) at least 200 square meters, and at least 500 square meters; (9) the second aspect or the first variation thereof wherein the buoyant structure includes a floating buoy or platform; and (10) the ninth variation of the second aspect wherein the buoyant structure has an effective area defining horizontal surface area contact with the water of greater than 10 square meters.

Numerous additional variations of the second aspect of the invention exist and include, for example: (11) the tenth variation of the second aspect wherein the effective area is selected from the group consisting of: (i) at least 20 square meters, (ii) at least 50 square meters, (iii) at least 200 square meters, and (iv) at least 500 square meters; (12) the second aspect or the first variation thereof wherein the base is supported by a boat or ship floating on a body of water; (13) the twelfth variation of the second aspect wherein the boat or ship has a water displacement selected from the group consisting of (i) at least about 2 tons but less than about 20 tons, (ii) at least about 20 tons but less than about 200 tons, and (iii) at least about 200 but less than about 2000 tons; (14) the second aspect or the first variation thereof wherein the base is mounted to a surface that is affixed to an inertial coordinate system; (15) the second aspect or any of the first to fourteenth variations thereof wherein the at least one linear actuator includes at least two linear actuators; (16) the fifteenth variation of the second aspect the at least two linear actuators include at least three linear actuators; (17) the sixteenth variation of the second aspect wherein the at least three linear actuators include at least four linear actuators; (18) the second aspect or any of the first to seventeenth variations thereof wherein the at least one linear actuator is selected from the group consisting of (i) a variable position magnetically-driven linear actuator, (ii) a hydraulic actuator, and (iii) a screw-driven linear actuator; (19) the second aspect or any of the first to eighteenth variations thereof wherein the at least one linear actuator is configured to allow unresisted linear motion when not actuated and made to move to hold a commanded position when actuated; and (20) the second aspect or any of the first to nineteenth variations thereof wherein the at least one linear actuator can provide an acceleration of moving components at an amount selected from the group consisting of: (i) greater than 2 m/s². (ii) greater than 5 m/s², (iii) greater than 10 m/s², (iv) greater than 20 m/s².

Still further variations of the second aspect of the invention exist and include, for example: (21) the second aspect or any of the first to twentieth variations thereof wherein the at least one crank arm includes at least two crank arms; (22) the second aspect or any of the first to twenty-first variations thereof wherein the at least one connector arm comprises at least two connector arms; (23) the second aspect or any of the first to twenty-second variations thereof wherein at least one rotational actuator is selected from the group consisting of: (i) a servo motor, (ii) a stepper motor, (iii) a direct drive motor; (24) the second aspect or any of the first to twenty-third variations thereof wherein the antenna includes a dish antenna; (25) the second aspect or any of the first to twenty-fourth variations thereof wherein the antenna is covered by a protective dome; (26) the second aspect or any of the first to twenty-fifth variations thereof additionally including one or more sensors selected from the group consisting of: (i) one or more encoders, (ii) one or more incoders, (iii) one or more GPS sensors with Euler angles, (iv) one or more GPS sensors without Euler angles, (v) one or more magnetic compass direction sensors, (vi) one or more gravitational datum sensors, (vii) one or more IMUs, and (viii) one or more gyroscopes wherein the one or more sensors are configured to provide position or angular orientation information of one or more system components; and (27) the second aspect or any of the first to twenty-sixth variations thereof wherein the controller provides motion commands to the linear and rotational actuators in response, at least in part, to differences between pointing direction of the antenna and an intended pointing direction of the antenna that is required to maintain the motion of the antenna on a preset sweeping path that is defined relative to fixed inertial coordinates.

In a third aspect of the invention, a movement and stabilization system for supporting and moving a radar antenna, includes: (a) a base; (b) a radar antenna; (c) a radar antenna support structure attached, directly or indirectly, to the base; (d) a rotatable shaft extending, directly or indirectly from the support structure along an azimuthal axis around which the radar antenna can rotate wherein the azimuthal axis has a fixed orientation with respect to the base, and wherein the azimuthal axis has, at least at times, a non-parallel orientation with respect to a vertical axis that points to a zenith; (e) at least one crank arm fixedly connected, directly or indirectly, to the radar antenna wherein the at least one crank arm extends, directly or indirectly, away from a rear of the antenna, includes at least one tilt axis engagement feature, wherein the tilt axis is, directly or indirectly, supported by the shaft and extends perpendicular to the azimuthal axis and allows pitch movement, and further includes at least one connector arm engagement feature; (f) a connector arm joining, directly or indirectly, the at least one connector arm engagement feature in a manner that allows rotational motion between the at least one connector arm and the at least one crank arm wherein the rotational motion occurs about an axis that is parallel to the tilt axis; (g) a first slide structure capable of translational movement along the azimuthal axis, wherein the slide structure connects, directly or indirectly, to a lower end of the at least one connector arm in a manner that allows rotation of the at least one connector arm such that translation of the slide structure causes motion of the at least one connector arm, the at least one crank arm, and tilting of radar antenna; (h) a second slide structure capable of translational movement along the azimuthal axis; (i) a bearing having first and second mounting features that can be rotated relative to each other about the azimuthal axis wherein the first mounting feature is fixedly, directly or indirectly, connected to the first slide structure and wherein the second mounting feature is fixedly, directly or directly, connected to the second slide structure; (j) at least one linear actuator having a moving end joined, directly or indirectly, to the second slide structure for translating the first and second slide structures along the azimuthal axis such that translational movement of the slide structures cause tilting of the antenna about the tilt axis while still allowing rotational motion of the antenna and first slide structure about the azimuthal axis relative to the second slide structure; (k) a rotational actuator for rotating the shaft such that the antenna is capable of rotary motion about the azimuthal axes; and (l) at least one controller for controlling the actuators to provide for rotating the antenna about the azimuthal axis and for tilting the antenna about the tilt axis such that any non-parallel difference in orientation between the azimuthal axis and the vertical axis is greater than a misorientation between a sweeping path of the antenna and a preset sweeping path of the antenna relative to the vertical axis.

Numerous variations of the third aspect of the invention exist and include, for example, the variations noted for the first and second aspects, mutatis mutandis.

In a fourth aspect of the invention, a radar apparatus, includes: (a) a base; (b) a magnetron for generating pulsed radar signals; (c) a radar antenna; (d) at least one wave guide for directing pulsed radar signals from the magnetron to the radar antenna; (e) a receiver for collecting and passing returning radar signals to a detector where the returning signals are generated from the interaction of the pulsed radar signals and an encountered target; (f) a radar antenna support structure attached, directly or indirectly, to the base; (g) a rotatable shaft extending, directly or indirectly from the support structure along an azimuthal axis around which the radar antenna can rotate wherein the azimuthal axis has a fixed orientation with respect to the base, and wherein the azimuthal axis has, at least at times, a non-parallel orientation with respect to a vertical axis; (h) at least one crank arm fixedly connected, directly or indirectly, to the radar antenna wherein the at least one crank arm extends, directly or indirectly, away from a rear of the antenna, includes at least one tilt axis engagement feature, wherein the tilt axis is, directly or indirectly, supported by the shaft and extends perpendicular to the azimuthal axis and allows pitch movement, and further includes at least one connector arm engagement feature; (i) a connector arm joining, directly or indirectly, the at least one connector arm engagement feature in a manner that allows rotational motion between the at least one connector arm and the at least one crank arm wherein the rotational motion occurs about an axis that is parallel to the tilt axis; (j) a first slide structure capable of translational movement along the azimuthal axis, wherein the slide structure connects, directly or indirectly, to a lower end of the at least one connector arm in a manner that allows rotation of the at least one connector arm such that translation of the slide structure causes motion of the at least one connector arm, the at least one crank arm, and tilting of radar antenna; (k) a second slide structure capable of translational movement along the azimuthal axis; (l) a bearing having first and second mounting features that can be rotated relative to each other about the azimuthal axis wherein the first mounting feature is fixedly, directly or indirectly, connected to the first slide structure and wherein the second mounting feature is fixedly, directly or directly, connected to the second slide structure; (m) at least one linear actuator having a moving end joined, directly or indirectly, to the second slide structure for translating the first and second slide structures along the azimuthal axis such that translational movement of the slide structures cause tilting of the antenna about the tilt axis while still allowing rotational motion of the antenna and first slide structure about the azimuthal axis relative to the second slide structure; (n) a rotational actuator for rotating the shaft such that the antenna is capable of rotary motion about the azimuthal axes; and (o) at least one controller for operating the radar to transmit pulses, to detect returning pulses, to rotate the antenna about the azimuthal axis, and to tilt the antenna about the tilt axis; and wherein any angular motion of the base is compensated for as rotation about the azimuthal axis and tilting of the antenna about the tilt axis provide a sweeping radar beam with an angle of motion about a vertical axis that is a selected angle of motion with a variation that is less than a variation of the angle of motion of the base relative to the vertical axis.

Numerous variations of the fourth aspect of the invention exist and include, for example the variations noted for the first and second aspects, mutatis mutandis.

In a fifth aspect of the invention, a radar apparatus, includes: (a) a base; (b) a magnetron for generating pulsed radar signals; (c) a radar antenna; (d) at least one wave guide for directing pulsed radar signals from the magnetron to the radar antenna; (e) a receiver for collecting and passing returning radar signals to a detector, wherein the returning signals are generated from the interaction of the pulsed radar signals and an encountered target; (f) a radar antenna support structure attached, directly or indirectly, to the base; (g) a rotatable shaft extending, directly or indirectly, from the support structure along an azimuthal axis around which the radar antenna can rotate wherein the azimuthal axis has a fixed orientation with respect to the base, and wherein the azimuthal axis has, at least at times, a non-parallel orientation with respect to a vertical axis; (h) at least one crank arm fixedly connected, directly or indirectly, to the radar antenna wherein the at least one crank arm extends, directly or indirectly, away from a rear of the antenna, includes at least one tilt axis engagement feature, wherein the tilt axis is, directly or indirectly, supported by the shaft and extends perpendicular to the azimuthal axis and allows pitch movement, and further includes at least one connector arm engagement feature; (i) a connector arm joining, directly or indirectly, the at least one connector arm engagement feature in a manner that allows rotational motion between the at least one connector arm and the at least one crank arm wherein the rotational motion occurs about an axis that is parallel to the tilt axis; (j) a first slide structure capable of translational movement along the azimuthal axis, wherein the slide structure connects, directly or indirectly, to a lower end of the at least one connector arm in a manner that allows rotation of the at least one connector arm such that translation of the slide structure causes motion of the at least one connector arm, the at least one crank arm, and tilting of radar antenna; (k) a second slide structure capable of translational movement along the azimuthal axis; (l) a bearing having first and second mounting features that can be rotated relative to each other about the azimuthal axis wherein the first mounting feature is fixedly, directly or indirectly, connected to the first slide structure and wherein the second mounting feature is fixedly, directly or directly, connected to the second slide structure; (m) at least one linear actuator having a moving end joined, directly or indirectly, to the second slide structure for translating the first and second slide structures along the azimuthal axis such that translational movement of the slide structures cause tilting of the antenna about the tilt axis while still allowing rotational motion of the antenna and first slide structure about the azimuthal axis relative to the second slide structure; (n) a rotational actuator for rotating the shaft such that the antenna is capable of rotary motion about the azimuthal axes; and (o) at least one controller for operating the radar to transmit pulses, to detect returning pulses, to rotate the antenna about the azimuthal axis, and to tilt the antenna about the tilt axis in such a way that a difference between an antenna pointing direction and a preset target direction of the antenna is on average less than a variation between the azimuthal axis and a vertical axis.

Numerous variations of the fifth aspect of the invention exist and include, for example, the variations noted for the first and second aspects, mutatis mutandis.

In a sixth aspect of the invention, an apparatus for supporting and moving at least one directionally sensitive signal receiver, wherein the apparatus includes: (a) a base; (b) at least one signal receiver that collects and passes signals to at least one receiver wherein the at least one signal receiver can be orientated in different directions to obtain signals emanating from one or more remote sources; (c) a receiver support structure attached, directly or indirectly, to the base; (d) a rotatable shaft extending, directly or indirectly, from the support structure along an azimuthal axis around which the at least one receiver can rotate wherein the azimuthal axis has a fixed orientation with respect to the base; (e) at least one crank arm fixedly connected directly or indirectly to the at least one receiver wherein the at least one crank arm extends, directly or indirectly, away from the at least one receiver and includes at least one tilt axis engagement feature, wherein the tilt axis is, directly or indirectly, supported by the shaft and extends perpendicular to the azimuthal axis and allows pitch movement, and further includes at least one connector arm engagement feature; (f) a connector arm joining, directly or indirectly, the at least one connector arm engagement feature in a manner that allows rotational motion between the at least one connector arm and the at least one crank arm wherein the rotational motion occurs about an axis that is parallel to the tilt axis; (g) a first slide structure capable of translational movement along the azimuthal axis, wherein the slide structure connects directly or indirectly to a lower end of the at least one connector arm in a manner that allows rotation of the at least one connector arm and such that translation of the slide structure causes motion of the at least one connector arm, the at least one crank arm, and tilting of the at least one receiver; (h) a second slide structure capable of translational movement along the azimuthal axis; (i) a bearing having first and second mounting features that can be rotated relative to each other about the azimuthal axis wherein the first mounting feature is fixedly, directly or indirectly, connected to the first slide structure and wherein the second mounting feature is fixedly, directly or indirectly connected to the second slide structure; (j) at least one linear actuator having a moving end joined, directly or indirectly, to the second slide structure for translating the first and second slide structures along the azimuthal axis such that translational movement of the slide structures cause tilting of the at least one receiver about the tilt axis while still allowing rotational motion of the at least one receiver and first slide structure about the azimuthal axis relative to the second slide structure; (k) a rotational actuator for rotating the shaft such that the at least one receiver is capable of rotary motion about the azimuthal axes; and (l) at least one controller for controlling the actuators to provide rotation of the at least one receiver about the azimuthal axis and tilting of the at least one receiver about the tilt axis.

Numerous variations of the sixth aspect of the invention exist and include, for example: (1) the at least one receiver support structure further supporting, directly or indirectly, an antenna for transmitting an interrogation signal that can be either reflected from the remote source to provide a return signal or otherwise can generate a return signal from the remote source capable of being received by the at least one receiver; (2) the first variation of the sixth aspect wherein the antenna concentrates the return signal on to the at least one receiver; (3) the second variation of the sixth aspect wherein the antenna includes a radar antenna, the interrogation signal includes a radar signal, the return signal includes a reflected signal, and the receiver send collected signals down a waveguide to a detector that has a fixed position relative to the base; (4) the receiver including a thermal (IR) camera which is the detector; (5) the receiver including an acoustic listening device which is the detector; (6) the sixth aspect and any of the first to fifth variations thereof wherein the bearing includes a face-mount crossed roller bearing; (7) the sixth aspect and any of the first to sixth variations thereof wherein the azimuthal axis has a variable orientation with respect to a zenith, due at least in part, to rocking movement that the base can undergo when the apparatus is in use; (8) the seventh variation of the sixth aspect wherein the base includes a buoyant structure that floats on a body of water; (9) the seventh variation of the sixth aspect wherein the base is mounted, directly or indirectly, to buoyant structure including a floating buoy or platform; and (10) either of the eighth or ninth variations of the sixth aspect wherein the buoyant structure has an effective area defining a horizontal surface area contact with the water selected from the group consisting of: (i) at least 10 square meters, (ii) at least 20 square meters, (iii) at least 50 square meters, (iv) at least 200 square meters, and (v) at least 500 square meters.

Numerous additional variations of the sixth aspect of the invention exist and include, for example: (11) the seventh variation of the sixth aspect wherein the base is supported by a boat or ship floating on a body of water; (12) the eleventh variation of the sixth aspect wherein the boat or ship has a water displacement selected from the group consisting of: (i) at least 2 tons but less than 20 tons, (ii) at least 20 tons but less than 200 tons, and (iii) at least 200 tons but less than about 2000 tons; (13) the sixth aspect or any of the first to seventh variations thereof wherein the base is mounted to a surface that substantially provides an inertial coordinate system; (14) the sixth aspect or any of the first to thirteenth variations thereof wherein the at least one linear actuator is selected from the group consisting of: (i) at least two linear actuators, (ii) at least three linear actuators; and (iii) at least four linear actuators; (15) the sixth aspect or any of the first to fourteenth variations thereof wherein at least one of the at least one linear actuator is selected from the group consisting of (i) a variable position magnetically-driven linear actuator, (ii) a hydraulic actuator, and (iii) a screw-driven linear actuator; (16) the sixth aspect or any of the first to fifteenth variations thereof wherein the at least one linear actuator is configured to allow unresisted linear motion when not actuated and made to move to hold a commanded position when actuated; (17) the sixth aspect or any of the first to sixteenth variations thereof wherein the at least one linear actuator can provide an acceleration of moving components at an amount selected from the group consisting of: (i) at least 2 m/s². (ii) at least 5 m/s², (iii) at least 10 m/s², and (iv) at least 20 m/s²; (18) the sixth aspect or any of the first to seventeenth variations thereof wherein the at least one crank arm includes at least two crank arms; (19) the sixth aspect or any of the first to eighteenth variations thereof wherein the at least one connector arm includes at least two connector arms; (20) the sixth aspect or any of the first to nineteenth variations thereof wherein the at least one rotational actuator comprises an actuator selected from the group consisting of: (i) a servo motor, (ii) a stepper motor, (iii) a direct drive motor; (21) the first variation of the sixth aspect or any of the second to twentieth variations of the sixth aspect to the extent they are directly or indirectly based on the first variation wherein the antenna includes a dish antenna.

Still further variations of the sixth aspect of the invention exist and include, for example: (22) the sixth aspect or any of its first to twenty-first variations wherein the at least one receiver is covered by a protective dome; and (23) the sixth aspect or any of its first to twenty-second variations additionally including one or more sensors selected from the group consisting of: (i) one or more encoders, (ii) one or more incoders, (iii) one or more GPS sensors with Euler angles, (iv) one or more GPS sensors without Euler angles, (v) one or more magnetic compass direction sensors, (vi) one or more gravitational datum sensors, (vii) one or more IMUs, and (viii) one or more gyroscopes wherein the one or more sensors are configured to provide position or angular orientation information of one or more system components.

In a seventh aspect of the invention, a movement and stabilization system for supporting at least one directionally sensitive receiver is mounted indirectly to a base that is subject to angular oscillation or rocking about two perpendicular axes that are each perpendicular to a vertical axis pointing to a zenith around which rotation is to occur, the system includes: (a) a base; (b) at least one signal receiver that passes signals to at least one receiver wherein the at least one signal receiver can be orientated in different directions to obtain signals emanating from one or more remote sources; (c) a receiver support structure attached, directly or indirectly, to the base; (d) a rotatable shaft extending, directly or indirectly, from the support structure along an azimuthal axis around which the at least one receiver can rotate wherein the azimuthal axis has a fixed orientation with respect to the base, and wherein the azimuthal axis has a variable orientation with respect to a zenith, due at least in part, to rocking movement that the base can undergo when the apparatus is in use; (e) at least one crank arm fixedly connected directly or indirectly to the at least one receiver wherein the at least one crank arm extends, directly or indirectly, away from at least one receiver and includes at least one tilt axis engagement feature, wherein the tilt axis is, directly or indirectly, supported by the shaft and extends perpendicular to the azimuthal axis and allows pitch movement, and further includes at least one connector arm engagement feature; (f) a connector arm joining, directly or indirectly, the at least one connector arm engagement feature in a manner that allows rotational motion between the at least one connector arm and the at least one crank arm wherein the rotational motion occurs about an axis that is parallel to the tilt axis; (g) a first slide structure capable of translational movement along the azimuthal axis, wherein the slide structure connects directly or indirectly to a lower end of the at least one connector arm in a manner that allows rotation of the at least one connector arm and such that translation of the slide structure causes motion of the at least one connector arm, the at least one crank arm, and tilting of the at least one receiver; (h) a second slide structure capable of translational movement along the azimuthal axis; (i) a bearing having first and second mounting features that can be rotated relative to each other about the azimuthal axis wherein the first mounting feature is fixedly, directly or indirectly, connected to the first slide structure and wherein the second mounting feature is fixedly, directly or indirectly connected to the second slide structure; (j) at least one linear actuator having a moving end joined, directly or indirectly, to the second slide structure for translating the first and second slide structures along the azimuthal axis such that translational movement of the slide structures cause tilting of the at least one receiver about the tilt axis while still allowing rotational motion of the at least one receiver and first slide structure about the azimuthal axis relative to the second slide structure; (k) a rotational actuator for rotating the shaft such that the at least one receiver is capable of rotary motion about the azimuthal axes; and (l) at least one controller for rotating the at least one receiver about the azimuthal axis and to tilt the at least one receiver about the tilt axis such that any rocking of the base is compensated for such that rotation about the azimuthal axis and tiling of at least one receiver about the tilt axis provide a directional sweeping with an angle of motion that is a selected angle of motion with a variation that is less than a variation of an angle of motion of the base.

Numerous variations of the seventh aspect of the invention exist and include, for example: (1) the at least one receiver support structure further supporting, directly or indirectly, an antenna for transmitting an interrogation signal that can be either reflected from the remote source to provide a return signal or otherwise can generate a return signal from the remote source capable of being received by the at least one receiver; (2) the first variation of the seventh aspect wherein the antenna concentrates the return signal on to the at least one receiver; (3) the second variation of the seventh aspect wherein the antenna includes a radar antenna, the interrogation signal includes a radar signal, the return signal includes a reflected signal, and the receiver send collected signals down a waveguide to a detector that has a fixed position relative to the base; (4) the first variation of the seventh aspect wherein the receiver includes a thermal (IR) camera which is the detector; (5) the first variation of the seventh aspect wherein the receiver includes an acoustic listening device which is the detector; (6) the seventh aspect or any of the first to fifth variations wherein the selected angle of motion can be varied upon command; (7) the seventh aspect or any of the first to sixth variations wherein the variation in the angle of motion includes an angle of motion selected from the group consisting of: (i) less than ¼ that of the base, (ii) less than ⅛ that of the base, (iii) less than 1/16 that of the base, (iv) less than 1/32 that of the base; (8) the seventh aspect or any of the first to seventh variations wherein the variation in the angle of motion is selected from the group consisting of: (i) less than 4° degrees, (ii) less than 2°, (iii) less than 1°, and (iv) less than ½°; (9) the seventh aspect or any of the first to seventh variations wherein the variation in the angle of motion is selected from the group consisting of: (i) smaller than 4° of positioning error when the a base motion orients the shaft at no more than 15° from vertical and a targeting direction is within an operational range of antenna orientation, (ii) smaller than 2° of positioning error when a base motion orients the shaft at no more than 15° from vertical and a targeting direction is within an operational range of antenna orientation, (iii) smaller than 1° of positioning error when the when a base motion orients the shaft at no more than 15° from vertical and a targeting direction is within an operational range of antenna orientation, (iv) smaller than ½° of positioning error when a base motion orients the shaft at no more than 15° from vertical and the targeting direction is within an operational range of antenna orientation. (v) smaller than 4° of positioning error when the a base motion orients the shaft at no more than 30° from vertical and a targeting direction is within an operational range of antenna orientation, (vi) smaller than 2° of positioning error when the a base motion orients the shaft at no more than 30° from vertical and a targeting direction is within an operational range of antenna orientation, (vii) smaller than 1° of positioning error when the a base motion orients the shaft at no more than 30° from vertical and a targeting direction is within an operational range of antenna orientation, and (ix) smaller than ½° of positioning error when the a base motion orients the shaft at no more than 30° from vertical and a targeting direction is within an operational range of antenna orientation; (10) the seventh aspect or any of the first to ninth variations wherein the roller bearing includes a face-mount crossed roller bearing; (11) the base including a buoyant structure that floats on a body of water;

Numerous additional variations of the seventh aspect of the invention exist and include, for example: (12) the base being mounted, directly or indirectly, to a buoyant structure that includes a floating buoy or platform; (13) either of the eleventh or twelfth variations of the seventh aspect wherein the buoyant structure has an effective area defining a horizontal surface area contact with the water selected from the group consisting of: (i) at least 10 square meters, (ii) at least 20 square meters, (iii) at least 50 square meters, (iv) at least 200 square meters, and (v) at least 500 square meters; (14) the eleventh variation of the seventh aspect wherein the base is supported by a boat or ship floating on a body of water; (15) the fourteenth variation of the seventh aspect wherein the boat or ship has a water displacement selected from the group consisting of: (i) at least 2 tons but less than 20 tons, (ii) at least 20 tons but less than 200 tons, and (iii) at least 200 tons but less than about 2000 tons; (16) the seventh aspect or any of the first to fifteenth variations wherein the at least one linear actuator is selected from the group consisting of: (i) at least two linear actuators, (ii) at least three linear actuators; and (iii) at least at least four linear actuators; (17) the seventh aspect or any of the first to sixteenth variations wherein at least one of the at least one linear actuator is selected from the group consisting of (i) a variable position magnetically-driven linear actuator, (ii) a hydraulic actuator, and (iii) a screw-driven linear actuator; (18) the seventh aspect or any of the first to seventeenth variations wherein the at least one linear actuator is configured to allow unresisted linear motion when not actuated and made to move to hold a commanded position when actuated; (19) the seventh aspect or any of the first to eighteenth variations wherein the at least one linear actuator can provide an acceleration of moving components at an amount selected from the group consisting of: (i) at least 2 m/s². (ii) at least 5 m/s², (iii) at least 10 m/s², and (iv) at least 20 m/s²; (20) the seventh aspect or any of the first to nineteenth variations wherein the at least one crank arm includes at least two crank arms; and (21) the seventh aspect or any of the first to twentieth variations wherein the at least one connector arm includes at least two connector arm.

Still further variations of the seventh aspect of the invention exist and include, for example: (22) the seventh aspect or any of the first to twenty-first variations wherein the at least one rotational actuator is selected from the group consisting of: (i) a servo motor, (ii) a stepper motor, (iii) a direct drive motor; (23) the third variation of the seventh aspect or any of fourth through twenty-second variations to the extent that they are based directly or indirectly on the third variation wherein the antenna includes a dish antenna; (24) the seventh aspect or any of the first to twenty-third variations wherein the at least one receiver is covered by a protective dome; (25) the seventh aspect or any of the first to twenty-fourth variations additionally including one or more sensors selected from the group consisting of: (i) one or more encoders, (ii) one or more incoders, (iii) one or more GPS sensors with Euler angles, (iv) one or more GPS sensors without Euler angles, (v) one or more magnetic compass direction sensors, (vi) one or more gravitational datum sensors, (vii) one or more IMUs, and (viii) one or more gyroscopes wherein the one or more sensors are configured to provide position or angular orientation information of one or more system components; and (26) the seventh aspect or any of the first to twenty-fifth variations wherein the controller provides motion commands to the linear and rotational actuators in response, at least in part, to differences between pointing direction of the antenna and an intended pointing direction of the antenna that is required to maintain the motion of the antenna on a preset sweeping path that is defined relative to fixed inertial coordinates.

In an eighth aspect of the invention, a movement and stabilization system for supporting at least one directionally sensitive receiver, includes: (a) a base; (b) at least one signal receiver that passes signals to at least one detector wherein the at least one signal receiver can be orientated in different directions to obtain signals emanating from one or more remote sources; (c) a receiver support structure attached, directly or indirectly, to the base; (d) a rotatable shaft extending, directly or indirectly, from the support structure along an azimuthal axis around which the at least one receiver can rotate wherein the azimuthal axis has a fixed orientation with respect to the base, and wherein the azimuthal axis has, at least at times, a non-parallel orientation with respect to a vertical axis that points to a zenith; (e) at least one crank arm fixedly connected directly or indirectly to the at least one receiver wherein the at least one crank arm extends, directly or indirectly, away from at least one receiver and includes at least one tilt axis engagement feature, wherein the tilt axis is, directly or indirectly, supported by the shaft and extends perpendicular to the azimuthal axis and allows pitch movement, and further includes at least one connector arm engagement feature; (f) a connector arm joining, directly or indirectly, the at least one connector arm engagement feature in a manner that allows rotational motion between the at least one connector arm and the at least one crank arm wherein the rotational motion occurs about an axis that is parallel to the tilt axis; (g) a first slide structure capable of translational movement along the azimuthal axis, wherein the slide structure connects directly or indirectly to a lower end of the at least one connector arm in a manner that allows rotation of the at least one connector arm and such that translation of the slide structure causes motion of the at least one connector arm, the at least one crank arm, and tilting of the at least one receiver; (h) a second slide structure capable of translational movement along the azimuthal axis; (i) a bearing having first and second mounting features that can be rotated relative to each other about the azimuthal axis wherein the first mounting feature is fixedly, directly or indirectly, connected to the first slide structure and wherein the second mounting feature is fixedly, directly or indirectly connected to the second slide structure; (j) at least one linear actuator having a moving end joined, directly or indirectly, to the second slide structure for translating the first and second slide structures along the azimuthal axis such that translational movement of the slide structures cause tilting of the at least one receiver about the tilt axis while still allowing rotational motion of the at least one receiver and first slide structure about the azimuthal axis relative to the second slide structure; (k) a rotational actuator for rotating the shaft such that the at least one receiver is capable of rotary motion about the azimuthal axes; and (l) at least one controller for controlling the actuators to provide for rotating the at least one receiver about the azimuthal axis and for tilting the at least one receiver about the tilt axis such that any difference in orientation between the azimuthal axis and the vertical axis is greater than a misorientation between a sweeping path of the at least one receiver and a preset sweeping path of the at least one receiver relative to the vertical axis.

Numerous variations of the eighth aspect of the invention exist and include, for example, the variations noted for the sixth and seventh aspects, mutatis mutandis.

In a ninth aspect of the invention, an apparatus for supporting and moving at least one beam emitter, includes: (a) a base; (b) at least one beam emitter connected to a beam source; (c) a beam emitter support structure attached, indirectly, to the base; (d) a rotatable shaft extending, directly or indirectly, from the support structure along an azimuthal axis around which the at least beam emitter rotates wherein the azimuthal axis has a fixed orientation with respect to the base; (e) at least one crank arm fixedly connected directly or indirectly to the at least beam emitter wherein the at least one crank arm extends, directly or indirectly, away from a rear of the at least beam emitter and includes at least one tilt axis engagement feature, wherein the tilt axis is, directly or indirectly, supported by the shaft and extends perpendicular to the azimuthal axis and allows pitch movement, and further includes at least one connector arm engagement feature; (f) a connector arm joining, directly or indirectly, the at least one connector arm engagement feature in a manner that allows rotational motion between the at least one connector arm and the at least one crank arm wherein the rotational motion occurs about an axis that is parallel to the tilt axis; (g) a first slide structure capable of translational movement along the azimuthal axis, wherein the slide structure connects directly or indirectly to a lower end of the at least one connector arm in a manner that allows rotation of the at least one connector arm and such that translation of the slide structure causes motion of the at least one connector arm, the at least one crank arm, and tilting of the at least one beam emitter; (h) a second slide structure capable of translational movement along the azimuthal axis; (i) a bearing having first and second mounting features that can be rotated relative to each other about the azimuthal axis wherein the first mounting feature is fixedly, directly or indirectly, connected to the first slide structure and wherein the second mounting feature is fixedly, directly or indirectly connected to the second slide structure; (j) at least one linear actuator having a moving end joined, directly or indirectly, to the second slide structure for translating the first and second slide structures along the azimuthal axis such that translational movement of the slide structures cause tilting of the at least one beam emitter about the tilt axis while still allowing rotational motion of the at least one beam emitter and first slide structure about the azimuthal axis relative to the second slide structure; (k) a rotational actuator for rotating the shaft such that the at least one beam emitter is capable of rotary motion about the azimuthal axes; and (l) at least one controller for controlling the actuators to provide rotation of the at least beam emitter about the azimuthal axis and tilting of the at least one beam emitter about the tilt axis.

Numerous variations of the ninth aspect of the invention exist and include, for example: (1) the at least one beam emitter being rotatable relative to the beam source such that an emission direction of the beam emitter can be changed independently of an orientation of the beam source; (2) the ninth aspect or the first variation thereof wherein the beam emitter includes a radar antenna and the beam is a radar beam, (3) the ninth aspect or the first variation thereof wherein the beam comprises a laser beam and the beam source comprises a laser; (4) the ninth aspect or the first variation thereof wherein the beam comprises a visible light beam, a UV beam, or an IR beam; (5) the ninth variation or any of the first to fourth variations thereof additionally comprising at least one fiber optic cable and at least one rotary fiber optic coupler for moving a beam from the beam source to the beam emitter; (6) The ninth aspect or any of the first to fifth variations thereof additionally comprising at least one reflector for shaping emitted radiation from the beam emitter into a beam (e.g. a parabolic reflector); and (7) The ninth aspect or any of the first to sixth variations thereof additionally comprising a receiver for receiving any return signals from an interaction between the beam and any encountered target or targets and wherein the receiver passes return signals to at least one detector.

In a tenth aspect of the invention, an apparatus for supporting and moving at least one directionally sensitive signal receiver includes: (a) a base; (b) at least one signal receiver that collects and passes signals to at least one receiver wherein the at least one signal receiver can be orientated in different directions to obtain signals emanating from one or more remote sources; (c) a receiver support structure attached, directly or indirectly, to the base; (d) a rotatable shaft extending, directly or indirectly, from the support structure along an azimuthal axis around which the at least one receiver can rotate wherein the azimuthal axis has a fixed orientation with respect to the base; (e) at least one crank arm fixedly connected directly or indirectly to the at least one receiver wherein the at least one crank arm extends, directly or indirectly, away from the at least one receiver and includes at least one tilt axis engagement feature, wherein the tilt axis is, directly or indirectly, supported by the shaft and extends perpendicular to the azimuthal axis and allows pitch movement, and further includes at least one connector arm engagement feature; (f) a connector arm joining, directly or indirectly, the at least one connector arm engagement feature in a manner that allows rotational motion between the at least one connector arm and the at least one crank arm wherein the rotational motion occurs about an axis that is parallel to the tilt axis; (g) a swash plate cable of cyclic motion and collective motion about the azimuthal axis via two more independently controllable actuators that connect to a second portion of the swash plate that can rotate relative to a first portion wherein the actuators can provide linear motion along the azimuthal axis and orientation variations relative to the azimuthal axis wherein the first portion of the swash plate connects directly or indirectly to a lower end of the at least one connector arm in a manner that allows rotation of the at least one connector arm and such collective motion of the linear actuators causes motion of the at least one connector arm, the at least one crank arm, and tilting of the at least one receiver and wherein the two or more actuators are joined directly or indirectly to the base of the system; (h) a rotational actuator for rotating the shaft such that the at least one receiver is capable of rotary motion about the azimuthal axes; and (i) at least one controller for controlling the actuators to provide rotation of the at least one receiver about the azimuthal axis and tilting of the at least one receiver about the tilt axis.

Other objects and advantages of various aspects and embodiments of the invention will be apparent to those of skill in the art upon review of the following teachings. The various aspects and embodiments of the invention, set forth explicitly herein or otherwise ascertained from the teachings herein, may address any one of the above objects alone or in combination, or alternatively may address some other object of the invention ascertained from the teachings herein. It is not intended that any specific aspect or embodiment of the invention (that is explicitly set forth herein or that is ascertained from the teachings herein) necessarily address any of the objects set forth above let alone address all these objects simultaneously, but some aspects and embodiments may address more than one of these objects simultaneously.

### BRIEF DESCRIPTION OF THE DRAWINGS

FIG. 1 provides an illustration of the primary mechanical components of a radar system 100 according to an embodiment of the invention.

FIG. 2A identifies visible components of the radar system 100 of FIG. 1 while FIG. 2B depicts a system similar to that of FIG. 2A with the following additions/exceptions: (1) FIG. 2B depicts an alternative antenna dish configuration, (2) FIG. 2B provides a waveguide feed for emitting signals toward the antenna dish and for receiving signals bouncing off the antenna dish that are being returned, and (3) FIG. 2B provides an example radome and radome skirt for protecting the system.

FIGS. 3A to 3B illustrate the ability of the antenna to change its pitch angle via motion of the linear actuators that direct a slider downward or upward relative to a pivot axis of a crankarm that supports the antenna which in turn results in rotation of the antenna upward or downward in an opposite manner to that of the slider.

FIGS. 4A to 4I illustrate the ability of the antenna to rotate through a complete 360° rotation about the azimuthal axis via a yaw motor (not shown) located in a radar/motor/electronics housing that turns a central shaft, a wave guide, an inner slip ring, an inner or upper bearing mount, and a connector arm standoff plate.

FIGS. 5A to 5B provide, respectively, a front view of a component support frame and a base (FIG. 5A) and an isometric view of the frame and the base (FIG. 5B) with a left facing, forward tilting orientation so that additional structural detail may be seen.

FIGS. 6A to 6E illustrate various isometric views of an individual linear actuator forming part of the system of FIG. 2A.

FIGS. 7A to 7C show different isometric views of a linear actuator assembly formed from a pair of linear actuators, a frame structure including a lower plate, four triangular supports, a pair for vertical plates and two intermediate connecting bars for holding the actuators together along with an upper plate that can be used to couple the upper portions of the moving arms of the two actuators together.

FIG. 8A shows a radar housing with a yaw plate rotatably mounted thereon while FIG. 8B shows a separated the yaw plate with a rotatable center section holding a waveguide connector.

FIGS. 9A-1 to 9A-4 provide isometric views of a completely assembled shaft structure while FIGS. 9B to 9D provide isometric views of individual portions of the structure.

FIGS. 10A and 10B provide two different isometric views of a slip ring with the slip ring functioning as a multi-line rotary connector that allows electrical connections to be maintained between stationary and rotating components.

FIGS. 11A to 11E provide isometric views of components that are to be assembled to form a connecting rod assembly as shown in FIG. 11F.

FIGS. 12A to 12E provide isomeric views of the components that can be assembled to form the faux swash plate of FIG. 12F.

FIGS. 13A to 13B provide an exploded view and an assembled view, respectively, of a rotatable connector arm assembly formed from a pair of connector arms of FIG. 11F, the faux swash plate of FIG. 12F and an upper joining arm.

FIG. 14 provides (1) an assembled view of the components and assemblies of FIGS. 9A-4, 13B, along with a crank arm, and antenna mount, along with a yet to be attached antenna.

FIG. 15 provides an exploded view of a stack of waveguide elements, along with an extra rotated view of each waveguide element wherein the waveguide elements are used in combination to direct radar signals from a magnetron to an antenna.

FIGS. 16A to 16C provide three additional isometric views of the upper end of the waveguide components as assembled with an antenna so that the relationship between the upper waveguide elements and the antenna can be better seen. FIG. 16D provides a waveguide feed component that connects to the waveguide components behind the antenna.

FIGS. 17A-17C provide three additional isometric views of the lower end of the waveguide components as assembled with other components so that they and their relationship with the other components can be more clearly seen.

FIG. 18 provides an isometric view of the rear of the antenna to allow a couple of electronic sensors to be seen.

FIG. 19 provides a three part illustration showing targeting parameters in the form of an inertial elevation angle (upper window) and inertial azimuthal angle (middle window) and a simplified flowchart (lower window) relating such targeting parameters, actual radar base angles, and antenna pointing angles to the creation of motion control commands which can be used to maintain coincident pointing of an antenna at target locations when the radar is supported by an unstable platform.

### DETAILED DESCRIPTION OF THE INVENTION

### Example 1: Mechanical Configuration

Various advantages and novel features of the present invention are described herein and will become even more apparent to those skilled in this art from the following detailed description. The preceding and following descriptions set forth a preferred embodiment of the invention is set forth by way of illustration of the best mode contemplated for carrying out the invention. As will be apparent to those of skill in the art after reviewing the disclosure set forth herein, embodiments of the invention are capable of modification in various respects without departing from the spirit of invention. Accordingly, the drawings and description of the embodiments set forth hereafter are to be regarded as illustrative in nature, and not as restrictive.

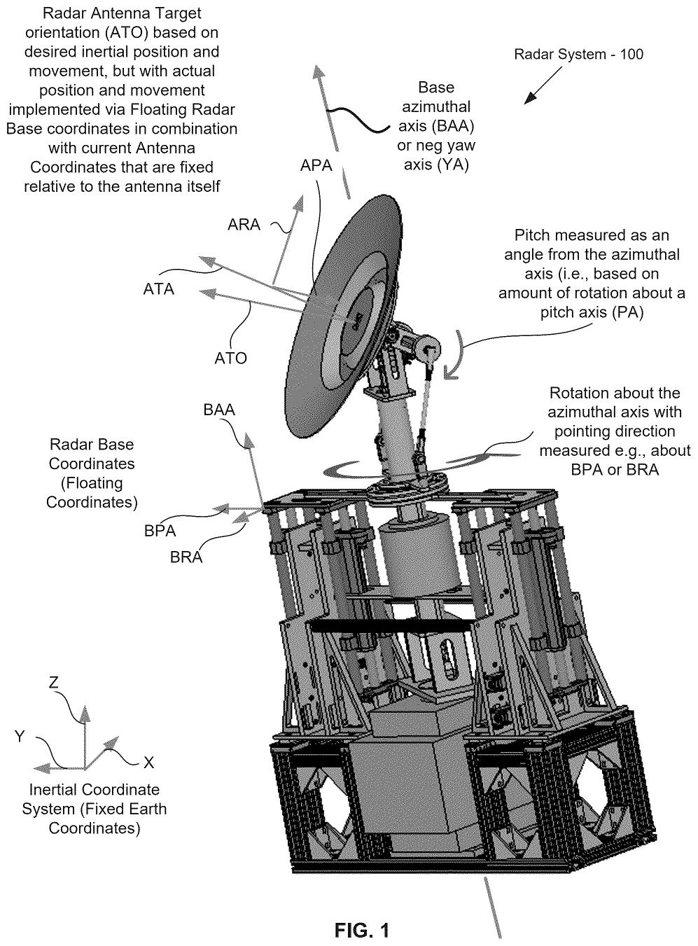

FIG. 1 provides an illustration of the primary mechanical components of a radar system 100 according to an embodiment of the invention. A radar antenna target orientation ATO is identified along with current antenna coordinate axes, current radar base coordinate axes (or floating coordinate axes), and inertial coordinate system axes (or inertial coordinate axes). A desired ATO in combination with these axes and their relative orientations can be used to provide antenna movement actuator commands. In some embodiments, commands may also be based on prior orientation information, rates of change of such orientation information, as well as information about other variables (e.g. anticipated wave motion for a system mounted to a floating platform) to provide enhanced or optimized commands. In the present illustration the radar base axes are identified as BPA (Base Pitch Axis), BRA (Base roll axis) and BAA (Base Azimuthal Axis) where the illustrated positioning of these axes (as well as that of other axes) are not necessarily shown at the most desirable origin positions so as to allow axis orientations to be more readily and clearly presented. The BAA may be antiparallel to a yaw axis and is preferably located along a line coincident with the center of the rotating shaft. In the present illustration the inertial coordinate orientations are illustrated as X, Y, and Z, where Z points to the zenith and X and Y represent fixed coordinate directions for use in defining a local orientation and position of the radar. X and Y are perpendicular to each other and to Z. X and Y, for example, may represent a local longitudinal axis and a local latitudinal axis. Coordinate axes for the antenna itself are also provided in the form of a current antenna axis ATA that points along a central line of a radar signal transmission direction) and two perpendicular axes which may provide an antenna pitch axis (APA) and an antenna roll axis (ARA). In other embodiments, other axes may be defined with the purpose of generating control commands and orientation feedback information for the antenna relative to the moving base and fixed inertial coordinate systems.

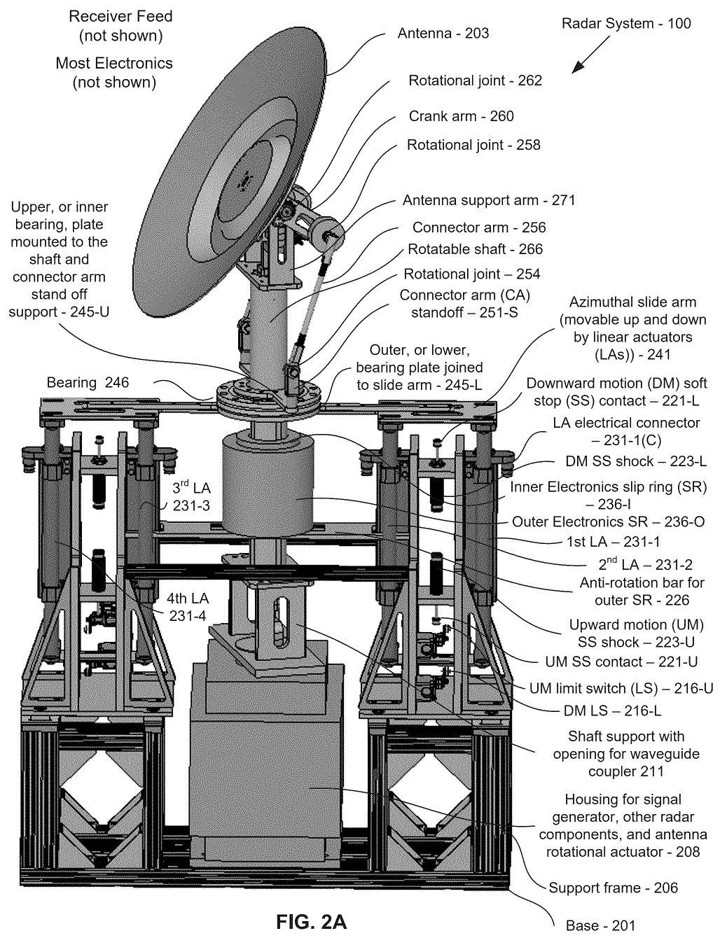

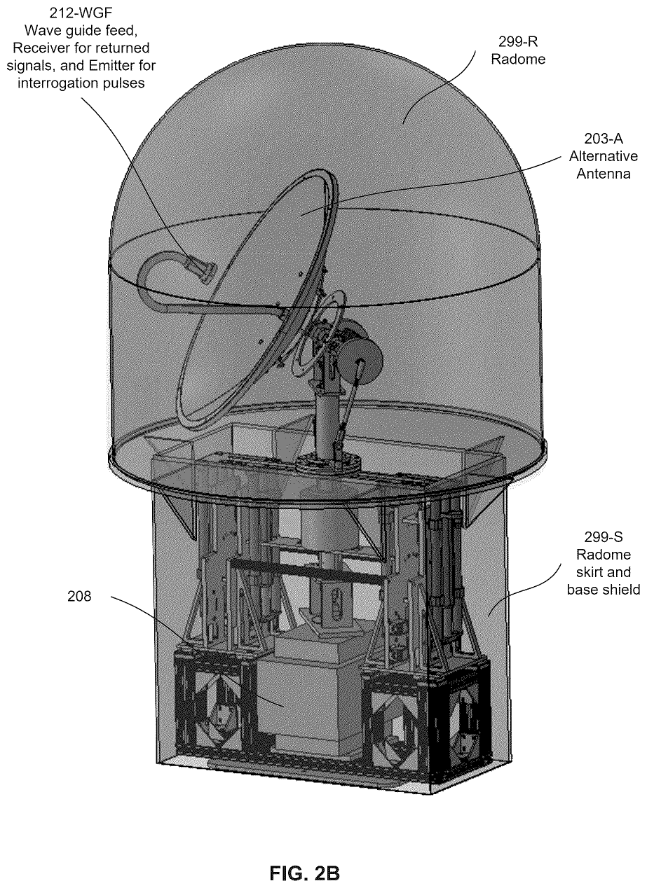

FIG. 2A identifies visible components of the radar system 100 of FIG. 1. The system 100 includes a base 201 which forms part a support frame 206. The base and frame of the present embodiment provide direct support for a housing 208 for a radar signal generator (e.g. a magnetron,) and for a rotational actuator (e.g. a rotational motor). The housing may also hold a portion of the electronic components used by the system, such as, for example, controllers that may be used in controlling radar antenna motion, signal transmission, signal reception, positional and rotational sensors, power storage, and communication. In some embodiments the radar system and rotation motor may take the form of a Furano radar system from Furano Electric Co. LTD of Nishinomiya City, Hyogo, Japan. The base and frame may also provide direct support for one or more linear actuator modules or assemblies as well as limit switches and other motion control components (e.g. motion damping components). The present embodiment provides two such modules. One such module includes first and second linear actuators (LAs) 231-1 & 231-2 while the other includes 3^{rd} and 4^{th} actuators 231-3 & 231-4. Each module also includes additional frame elements for supporting the actuators and other components such as, for example, upper and lower motion limit switches 216-U and 216-L as well as upper and lower soft stops that include contacts 221-U and 221-D as well as shocks 223-U and 223-L. Each linear actuator includes an electrical input connector with only connector 231-1(C) for linear actuator 231-1 being labeled in FIG. 2A. In some embodiments, all four linear actuators may be used to move slide arm 241 along the azimuthal axis while in others only a portion of the actuators may be used for any particular movement. In some embodiments the linear actuators, may for example, take the form of a linear motors from LinMot of Spreitenbach, Switzerland. The linear motors, as in the present embodiment, may include stabilizing guide arms as well as a powered arm.

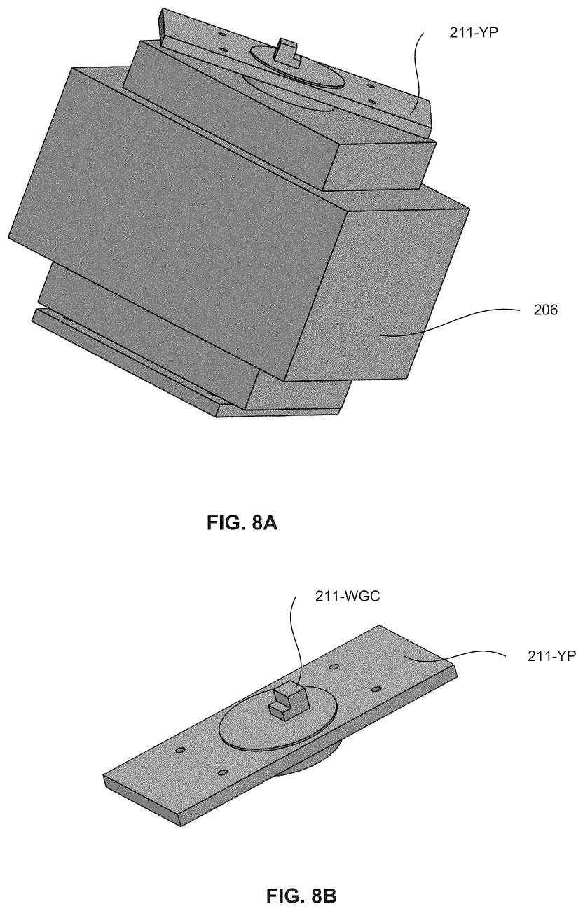

The housing 208 includes a rotary head (not shown in FIG. 2A but shown, for example, in FIGS. 8A and 8B) that rotates a shaft support structure 211 which holds a lower waveguide coupler as well as providing independent support for the shaft 266 itself. The linear actuator assemblies also support an anti-rotation bar 226 that in turn supports the outer ring 236-O of an electrical slip ring that provides electrical power and signals from frame-fixed non-rotating electrical components to components that rotate with the shaft via an inner ring 236-I. Slide arm 241 supports an outer or lower bearing plate 245-L which in turn supports a bearing 246 (which includes a lower or outer ring, intermediate rollers, and an upper or inner ring) which may, for example, take the form of a face-mount cross-roller bearing. The lower bearing plate is attached to and supports a lower ring of the bearing. The lower bearing plate and the lower ring do not rotate; however, they support via a plurality of rollers an inner or upper ring of the bearing which is attached to and supports an upper bearing plate 245-U that is capable of conjoined rotation with the shaft though it does not connect directly thereto.

Shaft 266 does not connect directly to the lower bearing plate 245-L, the bearing 246, or the upper bearing plate 245-U. It does, however, connect indirectly to upper bearing plate 245-U via combined connections between the upper bearing plate 245-U, connector arm standoff support 245-LB, connector arm standoffs 251-S, rotational joints 254, connector arms 256, rotational joints 258, crank arms 260, rotational joints 262, and antenna support arms 271 which are mounted, joined or bonded indirectly to shaft 266. The indirect connection of the upper bearing-plate 245-U to shaft 266 allows an azimuthal degree of freedom, or movement, of bearing plate 245-U with respect to the shaft 266 and both rotational and azimuthal degrees of freedom between the shaft 266 and lower bearing plate 245-L.

Bearing plate 245-U fixedly supports two vertically oriented connector arm standoffs 251-S via a pair of laterally extending, oppositely oriented arms. Standoffs 251-S pivotably connect to the lower ends of connector arms 256 via rotational joints 254 which may include bearings such as face mount cross-roller bearings. The upper ends of the connector arms 256 join crank arms 260 via rotational joints 258 which may include bearings such as face mount cross-roller bearings. The upper end of shaft 266 holds a laterally extending plate that in turn holds a pair of antenna support arms 271 to which antenna 203 connects via crank arms 260. Support arms 271 and crank arms 260 are pivotably connected via rotational joints 262 via an axle that is joined on either end to connector arms 256.

In other embodiments, other configurations and components, and component combinations may be used. For example, in some embodiments (as shown in FIG. 2B) the antenna and other system components may be protected by shielding from adverse environmental conditions (such as wind and water). The protection, for example, may take the form of a radome 299-R and a radome skirt and base shield 299-S that protects the radar system. FIG. 2B also provides an alternative antenna configuration 203-A, and a waveguide feed 212-WGF that acts as an emitter for directing interrogation radiation produced by a magnetron or other microwave source located in housing 208 toward the antenna and then reflecting it toward a region to be evaluated. The waveguide feed also acts as a receiver for receiving and collecting returning radiation that is reflected from the antenna and focused onto the feed which then directs the returning radiation down a waveguide path to a duplexer and then to a detector both of which are also located in radar housing 208 along with other electronics. In other embodiments, the emitter and receiver may take other forms. In some embodiments, the receiver may actually be a detector, a different type of radiation guide (e.g. a fiber optic, mirror, lens or other optical element), In some embodiments it may have a different relationship to an antenna, e.g. it may be located beside or behind a dish antenna when there is a secondary reflector or other shaping components in front of the dish that redirects radiation to the receiver. Similarly, an emitter may take different forms and have different relationships with a primary antenna. In some embodiments, both the emitter and receiver may function without a collaborating reflective antenna.

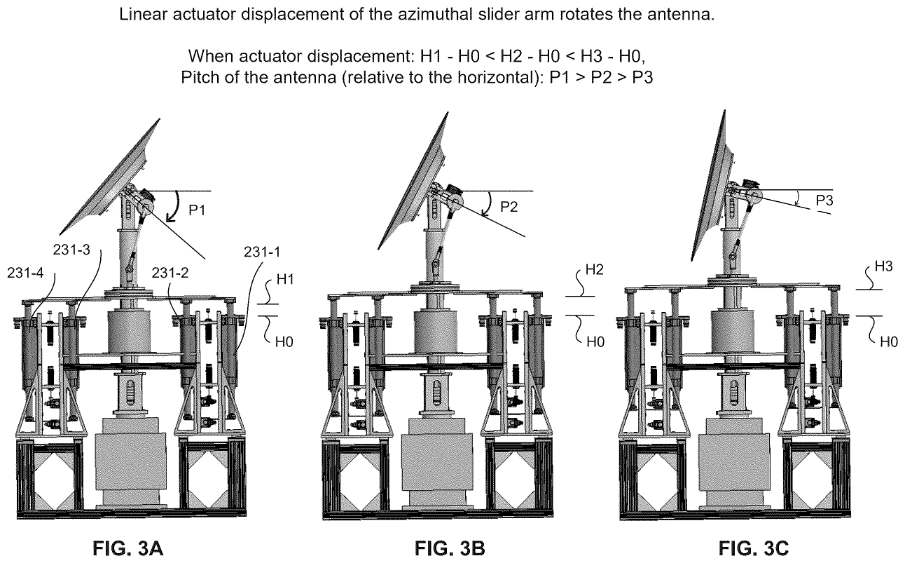

FIGS. 3A to 3B illustrate the ability of the antenna to change its pitch angle via motion of the linear actuators that direct a slider downward or upward relative to a pivot axis of a crankarm that supports the antenna which in turn results in rotation of the antenna upward or downward in an opposite manner to that of the slider. FIG. 3A shows a small azimuthal gap (H₁-H₀) between a hard stop H₀ and the position of the slider arm 241 at H₁ while the back of the antenna is shown at a pitch angle P1 relative to a horizontal plane (i.e., a plane having a normal parallel to the azimuthal axis) that provides a target pitch of the antenna with an angle P1 above the horizontal. In FIG. 3B, the slider arm has been lifted by movement of one or more of the linear actuators 231-1 to 231-4 to a position H₂ which has decreased the pitch angle to P2 thereby lowering the target pitch of the antenna. Similarly in FIG. 3C, the slider arm has been lifted by movement of one or more of the linear actuators to a position H₃ which has decreased the pitch angle to P3 thereby lowering the target pitch of the antenna even further. Thus controllable, variable linear movement of the slider arm results in a controllable pitch changes to the targeting direction of the antenna. In some alternative embodiments, instead of the pivot axis of the antenna being located between the antenna and the connector arm, the connector arm may engage the crank arm between the pivot axis and the antenna such that upward movement of the linear actuators results in an upward tilt of the antenna.

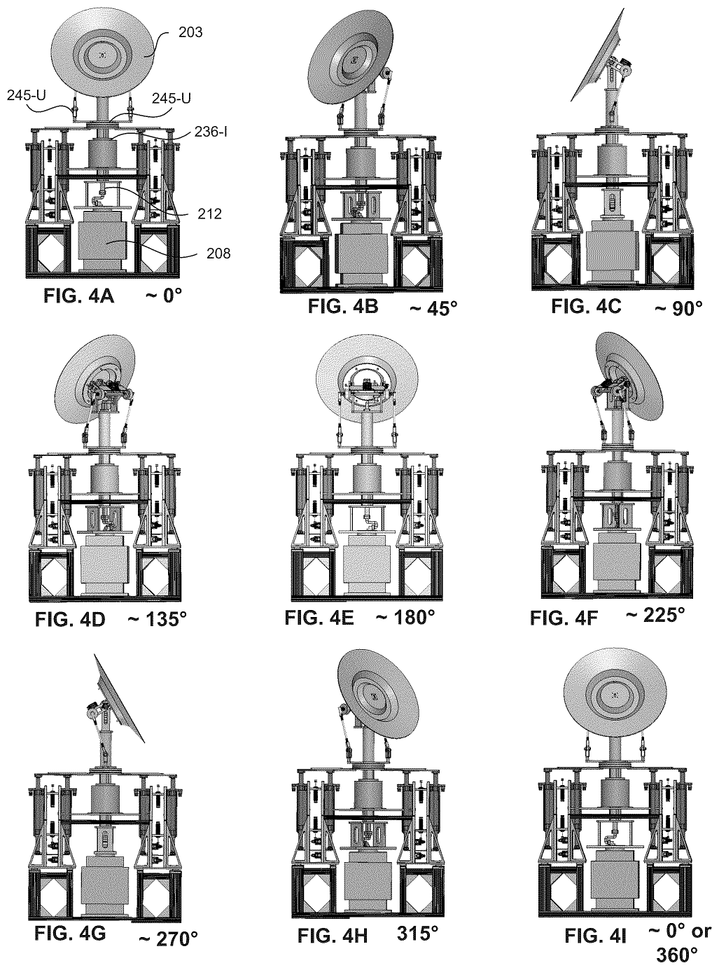

FIGS. 4A-4I illustrate the ability of the antenna to rotate through a complete 360° rotation about the azimuthal axis via a yaw motor (not shown) located in a radar/motor/electronics housing 208 that turns a central shaft 266, a wave guide assembly 212, an inner slip ring 236-I, an inner or upper bearing plate 245-U which includes or is connected to an extension plate that holds connector arm standoffs 251-S. FIG. 4A starts with the antenna facing out of the plane of the page with an example yaw angle of 0° and with an upward pitch. FIGS. 4A-4I show the antenna after incremental 45° rotations, respectively, in a clockwise direction when looking down along the azimuthal axis. In FIG. 4I, the antenna has rotated 360° to bring it back to its original position. After completing a full or partial sweep, the antenna may continue sweeping in the same direction for any number of additional rotations. In some alternative embodiments the antenna may be rotated in a counterclockwise manner. In other alternative embodiments, instead of performing full sweeps, the antenna may be directed to perform full or partial oscillations or back and forth sweeping motions with signals being sent and returned during one or both sweeping directions depending on what is intended to be ascertained. In some embodiments, the pitch may be changed with each rotation, or partial rotation. In situations where the base is rocking or even rotating about the azimuthal axis, pitch angle of the antenna relative to the base and rotational angle, or compass pointing direction, and associated rotation speed or direction may be varied so that the antenna targeting orientation tracks a desired elevation angle and rotational angle at all times. If the antenna is off target at any given time an error indicator and amount may be provided or captured for use in rejecting faulty data or applying corrective algorithms to adjust the data to provide partial or complete correction.

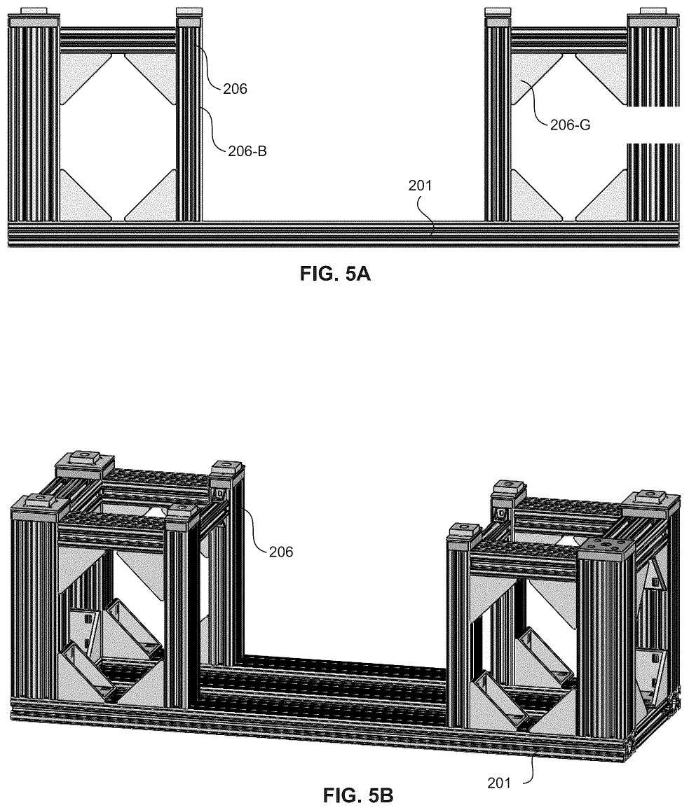

FIGS. 5A and 5B provide, respectively, a front view of a component support frame 206 and a base 201 and an isometric view of the frame and the base with a left facing, forward tilting orientation so that additional structural detail may be seen. In the present embodiment the frame is formed of beam-like or extruded structures 206-B oriented in parallel configurations and at right angle configurations as well as triangular brackets or gussets for joining and strengthening. In some embodiments frame elements may be permanently joined (e.g. by welding, riveting, or the like) or joined in a manner allowing for disassembly (e.g. by screws, clamps, or other readily removal fasteners). In other embodiments, the frame and base may take on numerous alternative configurations that provide adequate support and stability for the system components. As with other components and combinations of components forming the system, the base and frame are preferably formed from components and combinations of components that can withstand harsh environmental conditions or are otherwise provided with protective coatings or shields that provide adequate environmental protection against corrosion and other negative impacts associated with wet, salt laden and/or other corrosive environments.

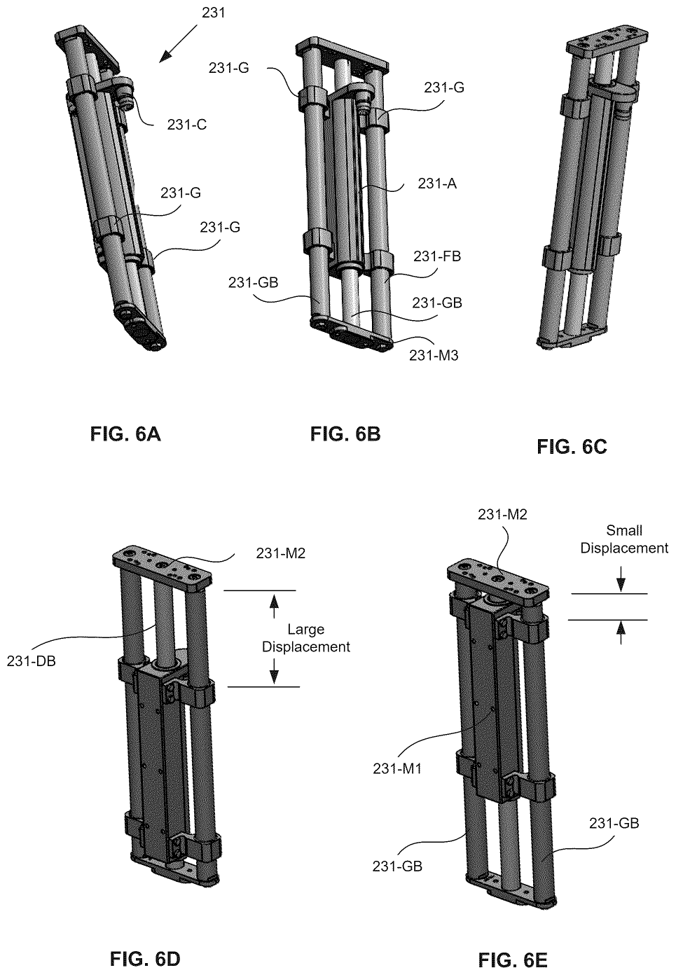

FIGS. 6A to 6E illustrate various isometric views of an individual linear actuator 231 forming part of the system of FIG. 2A. Actuator 231 includes a drive actuator 231-A, a drive bar or shaft 231-DB and outer, follower, guide bars 231-GB that help stabilize motion and that move with drive bar 231-DBa power and signal connector 231-C, a pair of guide bars 231-GB, four guide rings 231-G, first to third mounting surfaces 231-M1 to 231-M3 with 231-M2 and 231-M3 fixed with respect to one another at either end but movable with respect to 231-M1. As used in the embodiment of FIGS. 1 to 4I, mount 231-M1 is fixedly attached to the frame and base, while mounts 231-M2 and 231-M3 move up and down to cause tilt or pitch motion of the antenna. FIG. 6D shows the moving part of the actuator, including 231-M2, with a large upward displacement relative to 231-M1 while FIG. 6E shows the moving part of the actuator, including 231-M2, with a small upward displacement relative to 231-M1 (or 231-M3 with a large downward displacement relative to 231-M1). Linear motors can be controlled to provide any extension length by providing appropriate control of electric power through different windings or coils that engage multiple permanent magnets along the length of the stator or rotor elements.

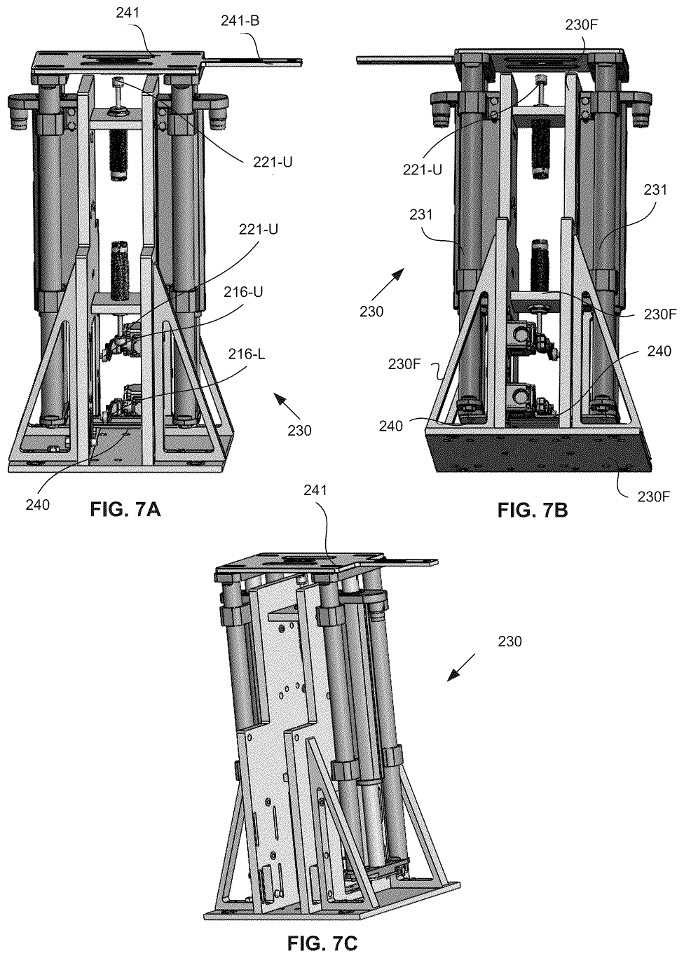

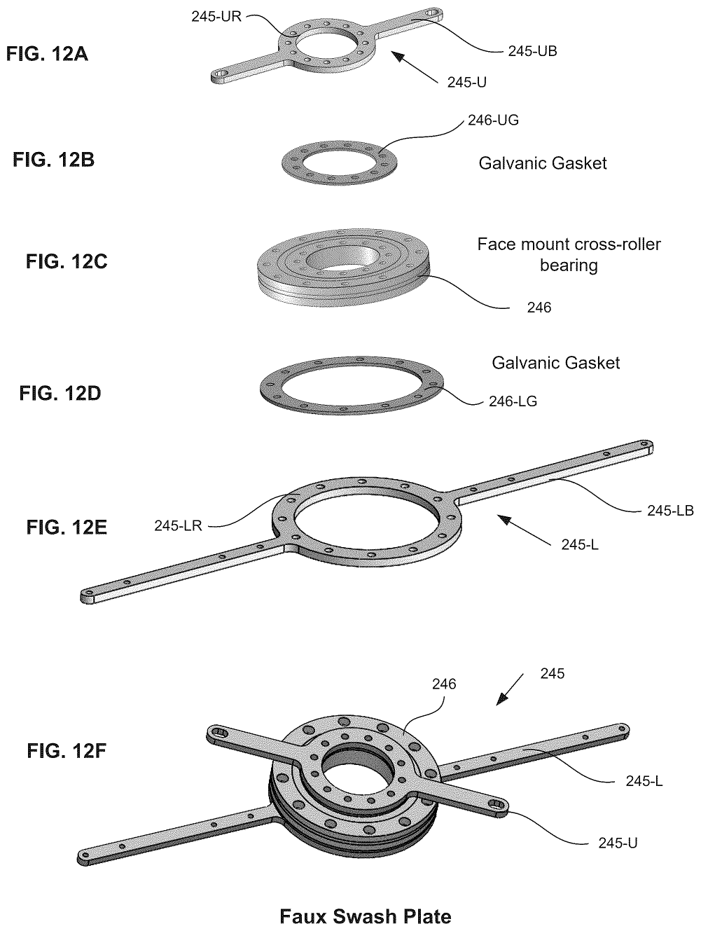

FIGS. 7A-7C show different isometric views of a linear actuator assembly 230 formed from a pair of linear actuators 231, a frame structure 230-F (including a base plate a pair of vertically extended mounting plates or bars, four gusset brackets and two, small, intermediate support plates that provide additional stabilization was well as soft stop component mounts) that holds the pair of the actuators 231 together along with an upper plate 241 and a lower plate 240 that can be used to couple the upper and lower portions of the moving arms of the two actuators 231 together. The upper plate 241 includes an extension arm 241-B that can be used for fixedly joining bearing assembly 245 via lower bearing plate arms 245-LB (see FIG. 12E). The upper plate 241 is also used as a contact surface for soft stop contact 221-U to provide braking as the downward motion of the actuator nears a downward motion limit hard stop or switch. Lower plate 240 joins the lower portions of the moving arms of the pair of actuators using connecting mounts 231-M3 of each actuator. Plate 240 is used for three purposes: (1) contacting the lower limit switch 216-L to halt downward motion of the moving actuator arms, (2) contacting the upper limit switch 216-U to halt upward motion of the moving actuators arms, and (3) contacting the contract tip 221-U of the lower soft stop during upward motion to provide a damping function.

FIG. 8A shows a radar housing 206 with a yaw plate 211-YP rotatably mounted thereon while FIG. 8B shows a separated yaw plate 211-YP. The yaw plate is coupled to a rotary top plate on the radar housing which can drive the rotation of the yaw plate as well as transmit radar signals though an opening in the bottom of the yaw plate to a waveguide coupler 211-WGC. The waveguide coupler 211-WGC can be joined to a waveguide adapter and other waveguide assembly components to direct signals from a magnetron in the waveguide housing to the antenna.

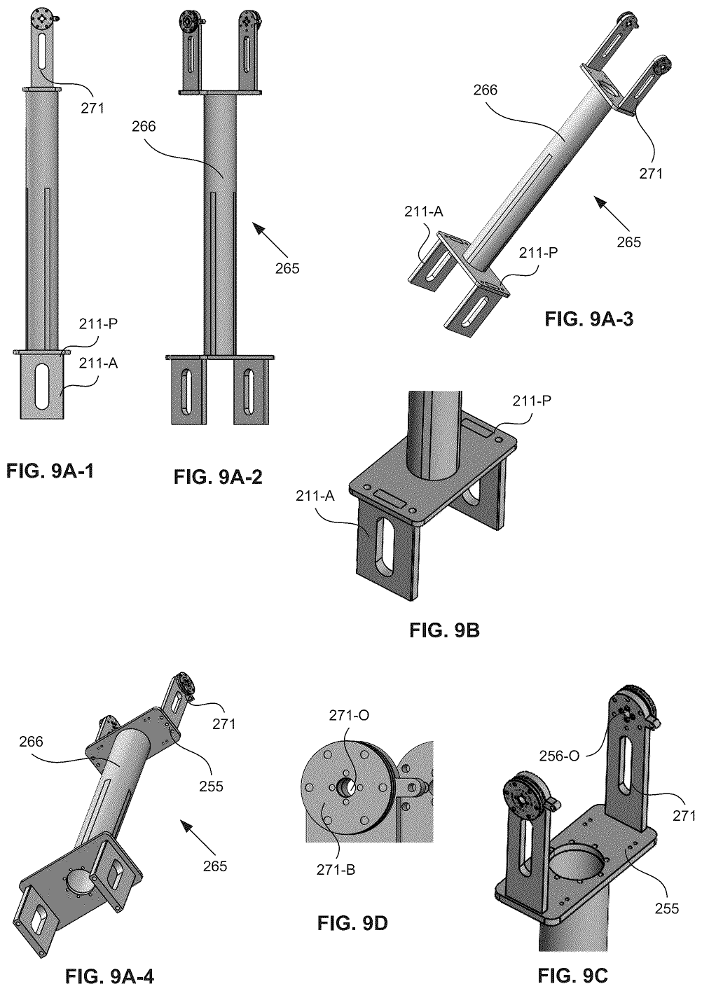

FIGS. 9A-1 to 9A-4, provide isometric views of a completely assembled shaft structure while FIGS. 9B, 9C, and 9D provide isometric views of individual portions of the shaft structure. The assembled shaft structure 265 includes a substantially cylindrical shaft 266, a lower plate 211-P and a pair of lower attachment arms 211-A that connect to the yaw plate to provide support for the shaft. The shaft 266 at the other end is provided with, joins, or connects to an upper plate 255 and vertical arms or antenna support arms 256 that have openings 256-O for receiving an antenna tilt axle that rotatably engages a pair of crank arms that connect to the back of the antenna.

FIG. 9B provides a close up of the lower plate 211-P and attachments arms 211-A, FIG. 9C provides a close up view of the upper plate 255 and vertical arms 271, and FIG. 9D provides a close up of one of the openings 271-O in the upper arms for accepting a crank axle. The openings 271-O are formed at least in part by bearing structures 271-B that provide for low friction rotational engagement with crank arms. Rotational coupling of opening 271-O and crank arms may occur via pins extending from the support arms into openings 271-O, pins or shafts that extend through 271-O as well as through openings in the crank arms, or any other coupling structure that provide stable and low friction movement.

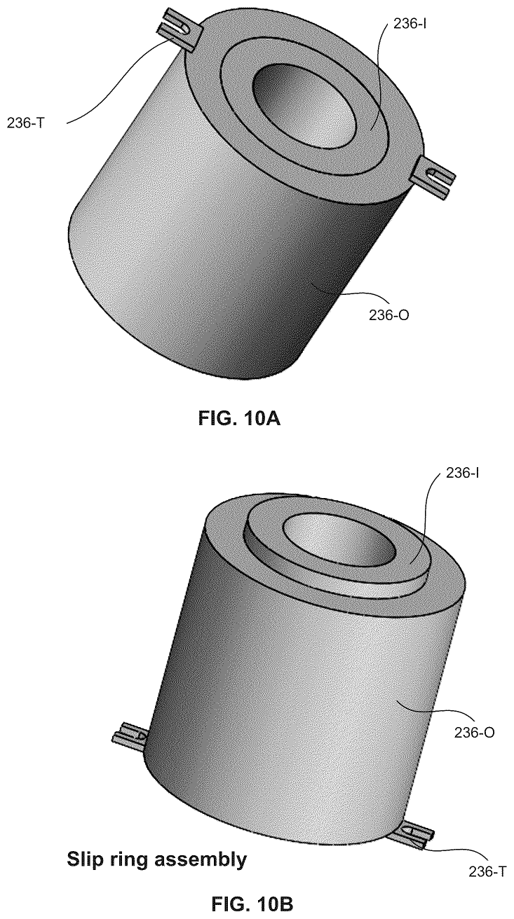

FIGS. 10A and 10B provide two different isometric views of a slip ring 236 with the slip ring functioning as a multi-line rotary connector that allows electrical connections to be maintained between stationary and rotating components. In some embodiments, the slip ring may provide for 20 separate rotational connections while in others it may provide fewer or a greater number of connections. The slip ring includes an inner ring 236-I that rotates with the antenna shaft and an outer ring 236-O that is attached to an anti-rotation bar via two taps 236-T. An opening through the center of the inner slip ring allows the ring to be positioned around central shaft 266. Keyed features may exist between the inner slip ring and the shaft to provide coupling or coupling may be achieved in some other manner (e.g. bolts, bonding, pressing fitting, or the like).

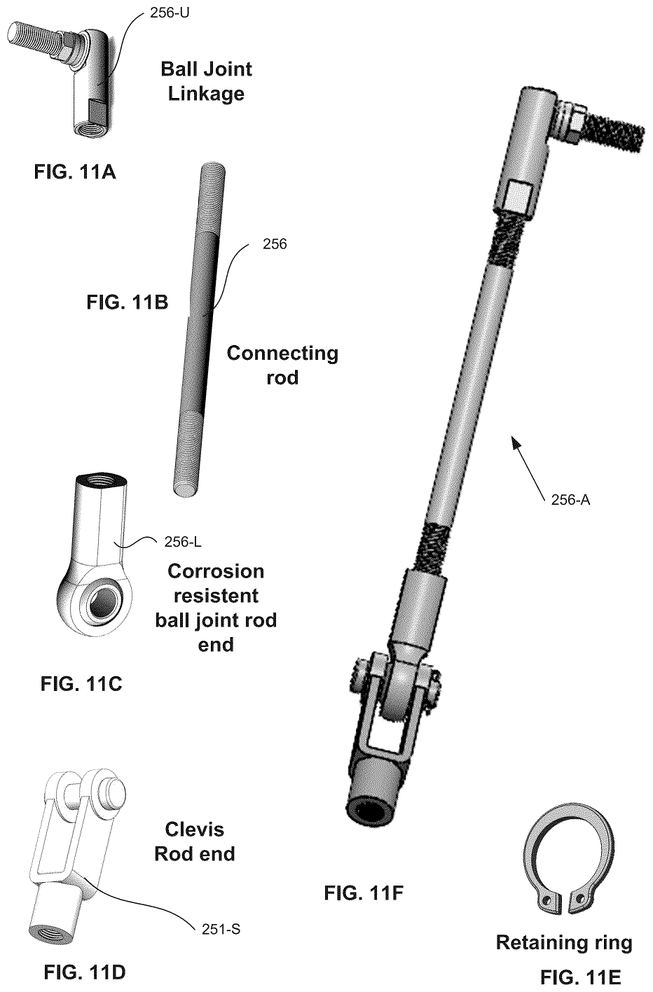

FIGS. 11A-11E provide isometric views of components that are to be assembled to form a connecting rod assembly 256-A as shown in FIG. 11F. FIG. 11A depicts a ball joint linkage 256-U having a threaded receptacle that forms an upper end of the connecting rod assembly 256-A of FIG. 11F as well as a threaded arm expending perpendicular to the threaded receptacle for receiving an at least partially hollow bar or rod having threaded receptacles at each end. FIG. 11B depicts a connecting rod 256 that has threads on each end with its upper end screwable into the threaded receptacle of ball joint linkage 256-U. FIG. 11C depicts a corrosion resistant ball joint rod end 256-L that is threaded and is cable of receiving the lower end of the connecting rod 256. The opening through the ball joint receptacle portion is capable of receiving a pen that FIG. 11D depicts a clevis rod end or connector rod standoff 251-S that is threaded at its lower end and has two parallel, spaced apart arms that extend upward with a removable pin extending through an opening in each wherein the pin and arms can be used to engage the opening in ball joint 256-L that connects to the lower end of rod 256. FIG. 11E depicts a retaining ring for engaging and retaining the pin of the clevis rod once it has engaged the ball joint. The lower end of the clevis rod is configured with a threaded receptacle for attachment to bar 245-UB of the upper bearing plate 245-U with a bolt.

FIGS. 12A to 12E provide isomeric views of the components that can be assembled to form the faux swash plate of FIG. 12F. The assembly 245 of FIG. 12F includes a lower bearing plate 245-L that has a central ring structure 245-LR and oppositely extending arms 245-LB as seen in FIG. 12E. Arms 245-LB are configured for attachment to extension arms 241-B of the linear actuator assemblies. The lower ring of 245-L in turn sits below and mounts to a lower and outer surface of the lower cross-mount roller bearing 246 as shown in FIG. 12C via an intermediate galvanic gasket 246-LG as shown in FIG. 12D. An inner and upper portion of the cross-mount roller bearing 246 is joined to an upper bearing plate 245-U having a smaller ring structure 245-UR and oppositely extending arms 245-UB as seen in FIG. 12A via an intermediate galvanic gasket 246-UG. The arms 245-UB provide a mounting surface for standoffs 251 that is rotatable relative to the lower bearing plate 245-L.

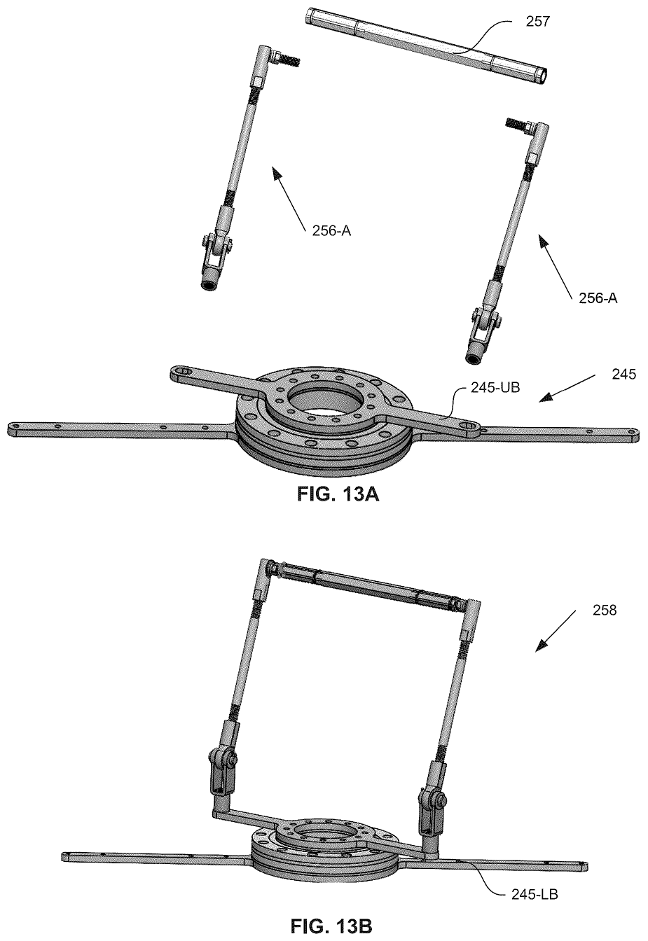

FIGS. 13A-13B provide an exploded view and an assembled view, respectively, of a rotatable connector arm assembly. The assembly 258 is formed from two connector arm subassemblies 256-A, an axle 257 that joins the upper portions of the arm assemblies along with the faux swash plate 245 that joins the lower ends of the arm subassemblies. The assembly provides a connector arm assembly that may undergo azimuthal motion at its bottom end (i.e., at lower bearing plate arm 245-LB while being configured to implement rotational motion at its upper end (i.e., at axle 257) when engaging a crank arm.

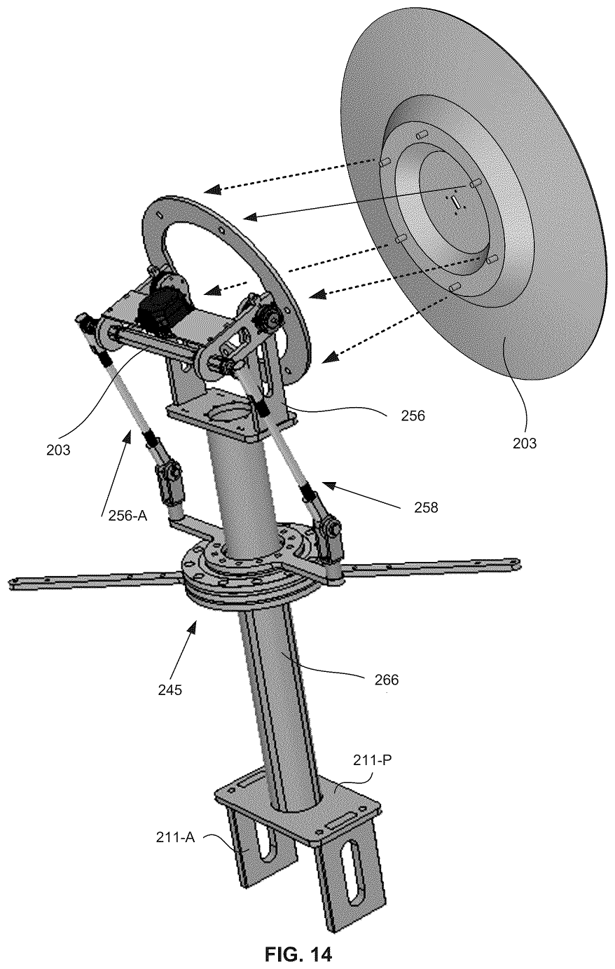

FIG. 14 provides (1) an assembled view of the components and assemblies of FIGS. 9A-1 to 9A-4, and 3-B, along with an antenna mount and associated crank arm, and (2) an exploded view of these assemblies in combination with antenna 203.

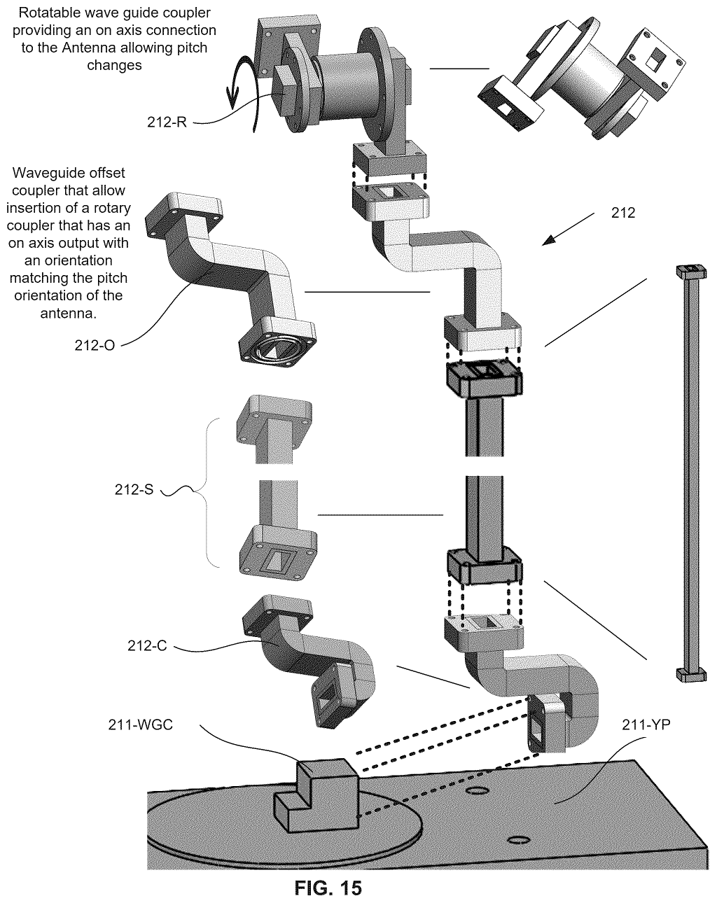

FIG. 15 provides an exploded view of a stack of waveguide elements, along with an extra rotated view of each waveguide element wherein the waveguide elements are used in combination to direct radar signals from a magnetron to an antenna. In the present embodiment the radio waves coming from the rotating yaw plate are not directed azimuthally and they are not directed along a rotation axis of the yaw plate. As such the first wave guide component joining the yaw plate waveguide coupler 211-WGC is a redirection and offset coupler or adapter 212-C which when mounted to the yaw plate redirects the radio waves to an axis parallel and coincident with an axis of rotation of the shaft. Next the radio waves are feed into a long straight waveguide 212-S that extends up the center of the shaft. At the top of the shaft, the radio waves are fed into an offset waveguide coupler 212-O that shifts the radio waves to a parallel but off axis to provide space for a rotary coupler 212-R that can provide rapid rotary reorientation of its upper end so that output radiation can be directed along the central axis (or targeting axis) of the antenna to match the adjustable pitch orientation of the antenna. Each wave guide component is shown in two different orientations so that upper and lower waveguide channels and coupling features may be better seen in relation to other components.

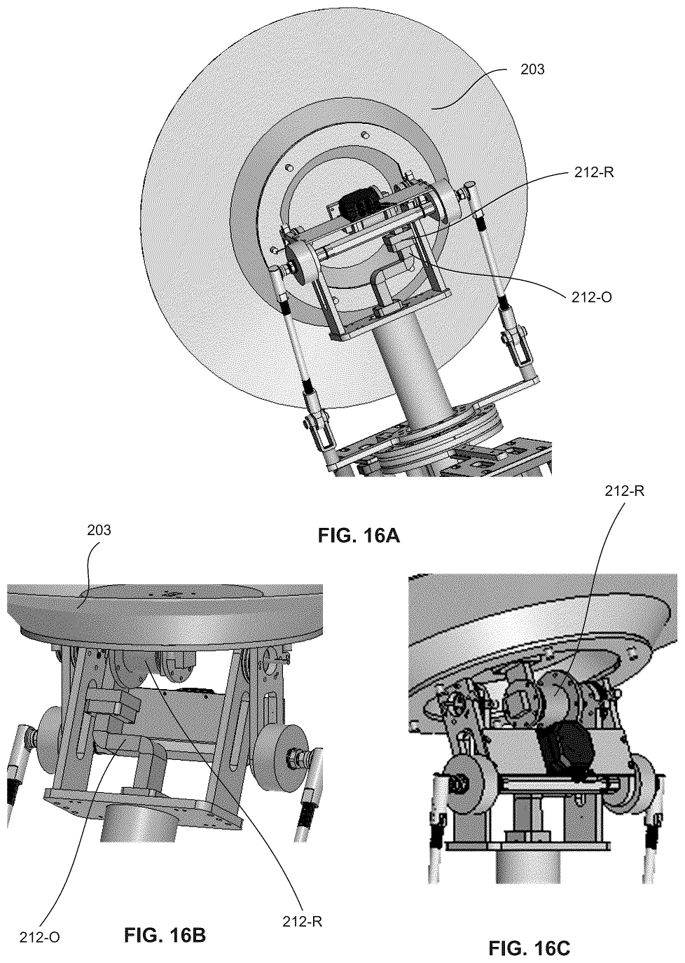

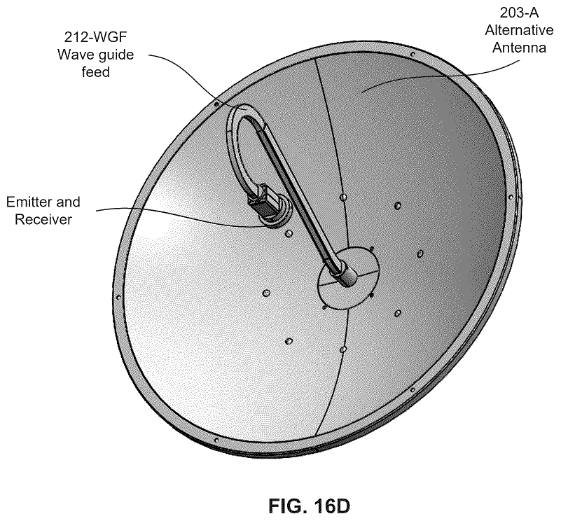

FIGS. 16A-16C provide three additional isometric views of the upper end of the waveguide components so that the relationship between the upper waveguide elements 212-O and 212-R and the antenna can be better seen. FIG. 16D provides an alternative antenna configuration 203-A and an additional wave guide component 212-WGF that connects to the waveguide components behind the antenna and particularly to 212-R providing a continuous path from 211-WGC to the distal end or feed end of 212-WGF such that the feed end can function as an emitter of radiation that comes up the waveguide that can be bounced of the antenna and reflected in a direction of interest for interrogation and as a collector of radiation that is returned from any objects located in the direction which can be directed down the wave guide to a detector.

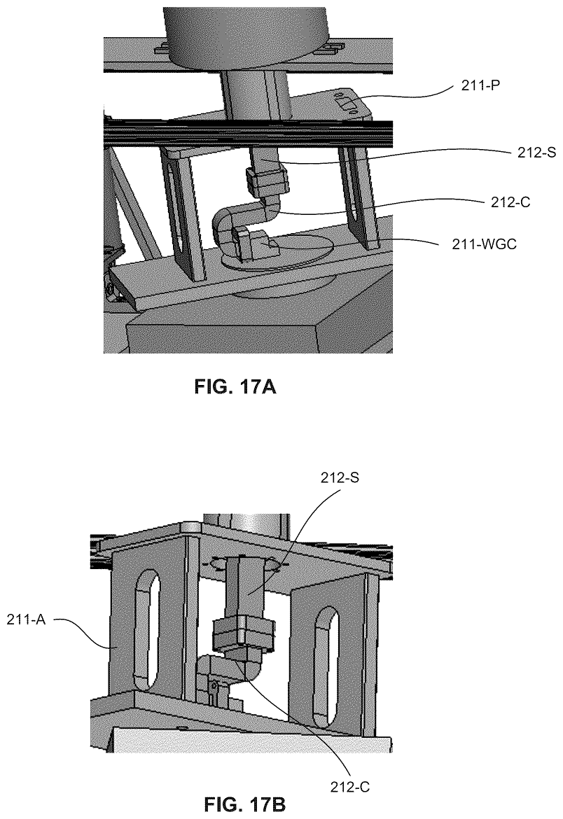

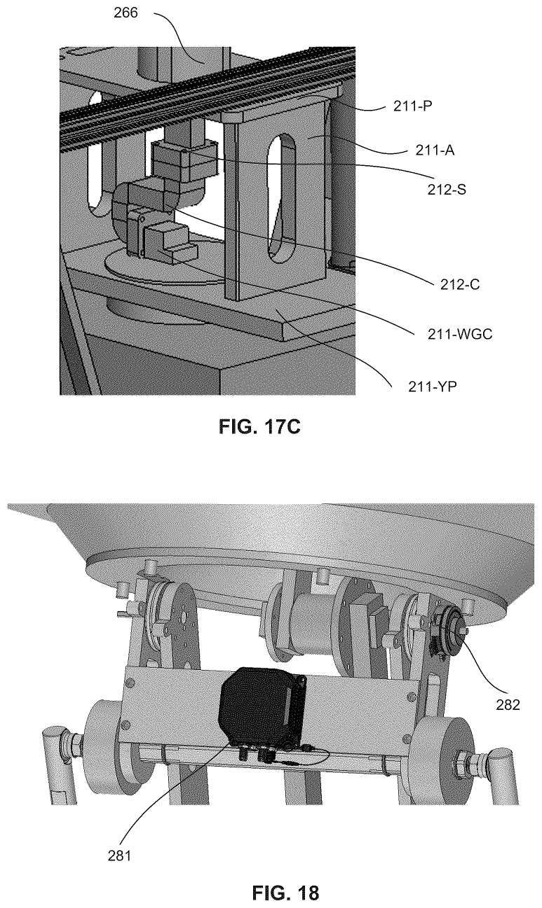

FIGS. 17A-17C may provide three additional isometric views of the lower end of the waveguide components 211-WGC, 212-C, and 212-S so that they can be more clearly seen in relation to other components.

FIG. 18 provides an isometric view of the rear of the antenna to allow a couple of electronic sensors to be seen. An incorporated GPS unit and/or IMU unit 281 can be seen mounted to a plate that has a fixed position relative to the antenna such that its motion may be used for providing data about the antenna positioning. An encoder and/or and inductive encoder (i.e., incoder) 282 can also be seen which is mounted to the pivot axis of the crank arm so that data about antenna pitch may be obtained or verified. In alternative embodiments, additional encoders or incoders may be used along with additional IMUs and/or GPS units. In some embodiments, limit switches may also be used to set motion stop positions and/or to allow for resetting or calibration of sensor readings. Additional sensors such as gyroscopes, gravitational sensors, compass direction sensors, wind sensors, temperature sensors, video cameras, and the like may be integrated into the radar system directly or as part of a floating platform to which the radar is mounted. These components may be fixed to the pitching antenna, the rotating shaft, movable frame or possibly a floating device to which the frame is attached. In still other embodiments additional electronic systems may be incorporated to provide data processing, data storage, programming capability, communication capability, enhanced actuator control and feedback loops. Though closed loop feedback and even predictive feedback is generally preferred in some embodiments or operational conditions, open loop control may be adequate. In some embodiments, redundant components may be provided and used simultaneously or turned on if abnormalities are perceived or system verification is to be performed.

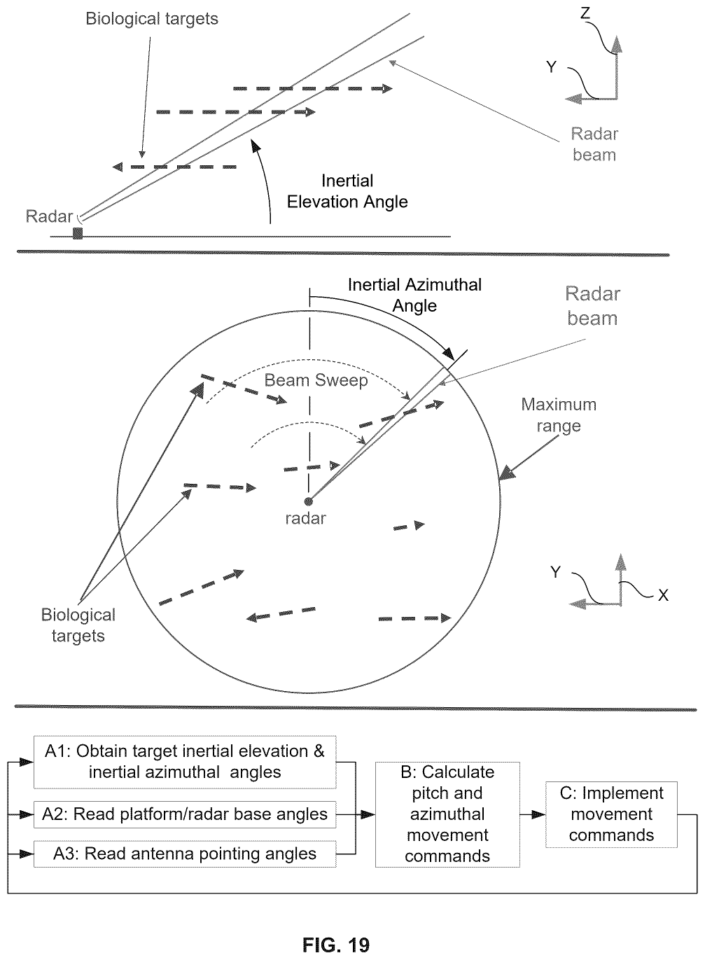

FIG. 19 provides a three part illustration showing targeting parameters (inertial elevation angle and inertial azimuthal angle) and a simplified flowchart relating such targeting parameters, actual radar base angles, and antenna pointing angles to creation of motion control commands with the reading, obtaining, calculating, and implementing repeated over and over to maintain coincident pointing of an antenna along a target path (at potential target locations) when the radar is supported by an unstable platform. In particular, an upper window provides a schematic side view looking along an inertial x-axis illustrating a radar beam pointing in a target direction in the Y-Z plane where the beam is intended to have a desired inertial elevation angle, a middle window provides a down-facing view of a radar beam that sweeps a path projected on the Y-Z plane resulting from the rotating of the pointing direction about an inertial azimuthal or vertical axis wherein a target orientation of the beam is defined by an inertial azimuthal angle, and a lower window that that provides a simplified flowchart showing the inputs that are used to perform calculations that in turn are used to define radar antenna reorientation commands that are based on any changes in inertial targeting position as well as changes in radar base orientation that might result from movement caused by waves or wind (e.g., oscillatory motion, compass direction rotation, rocking motion, and in some case may even account for translational motion of the system) as the radar system floats on a body of water. In alternative embodiments different variables and calculations may be used to provide alternative motion commands which may consider not only current measurement values but projected measurement values and/or anticipated system movements to further enhance pointing movement and stabilization.

The above embodiments used a faux swashplate configuration for controlling tilt or pivot angle of a pointing or monitoring system and more particularly for controlling the tilt of a movable head portion of the system. In alternative embodiments, instead of using a faux swash plate that is limited to linear motion along an azimuthal axis along with rotational motion about the azimuthal axis without any tilting reorientation or the swashplate relative to the azimuthal axis, other embodiments may use an actual swash plate that undergoes both linear motion (collective control) and tilting (cyclic control) to provide further control of any antenna, receiver, and/or emitter orientation. In some embodiments, such tilting may be provided by two independently controllable linear actuators located on opposite sides of the azimuthal axis which could be used for limited swashplate tilting in a plane defined by the line connecting that actuators and the azimuthal axis. In other embodiments, such collective and cyclic control may be provided by three or more independently controllable linear actuators which could be used to provide full swashplate titling. In either case, the swashplate may be tilted to maintain (to the extent possible) the swash plate in a nominal horizontal orientation regardless of base movement. In such embodiments one or more crank arms can extend from a rotatable portion of the swash plate which may be moved by collective motion of the actuators to provide required tilt orientation (e.g. variable tilt as the antenna rotates around the azimuthal axis.

### Additional Remarks

It is intended that the aspects of the invention set forth specifically herein or otherwise ascertained from the present teachings represent independent invention descriptions which Applicant contemplates as full and complete, and that Applicant believes may be set forth as independent claims without need of importing additional limitations or elements from other embodiments or aspects set forth herein for interpretation or clarification. It is also understood that any variations of the aspects (as well as variations in any embodiments) set forth herein represent individual and separate features that may form separate independent claims, be individually added to other claims, or added as new dependent claims to further define an invention being claimed by such claims.

While various preferred embodiments of the invention are shown and described, it is to be distinctly understood that this invention is not limited thereto but may be variously embodied From the foregoing description, it will be apparent that various changes may be made without departing from the spirit and scope of the invention as defined by the following claims.

1. An apparatus for supporting and moving at least one directionally sensitive signal receiver, comprising:
(a) a base;
(b) at least one signal receiver that collects and passes signals to at least one detector wherein the at least one signal receiver can be orientated in different directions to obtain signals emanating from one or more remote sources;
(c) a receiver support structure attached, directly or indirectly, to the base;
(d) a rotatable shaft extending, directly or indirectly, from the support structure along an azimuthal axis around which the at least one receiver can rotate wherein the azimuthal axis has a fixed orientation with respect to the base;
(e) at least one crank arm fixedly connected directly or indirectly to the at least one receiver wherein the at least one crank arm extends, directly or indirectly, away from a rear of the at least one receiver and comprises at least one tilt axis engagement feature, wherein the tilt axis is, directly or indirectly, supported by the shaft and extends perpendicular to the azimuthal axis and allows pitch movement, and further includes at least one connector arm engagement feature;
(f) a connector arm joining, directly or indirectly, the at least one connector arm engagement feature in a manner that allows rotational motion between the at least one connector arm and the at least one crank arm wherein the rotational motion occurs about an axis that is parallel to the tilt axis;
(g) a first slide structure capable of translational movement along the azimuthal axis, wherein the slide structure connects directly or indirectly to a lower end of the at least one connector arm in a manner that allows rotation of the at least one connector arm and such that translation of the slide structure causes motion of the at least one connector arm, the at least one crank arm, and tilting of the at least one receiver;
(h) a second slide structure capable of translational movement along the azimuthal axis;
(i) a bearing having first and second mounting features that can be rotated relative to each other about the azimuthal axis wherein the first mounting feature is fixedly, directly or indirectly, connected to the first slide structure and wherein the second mounting feature is fixedly, directly or indirectly connected to the second slide structure;
(j) at least one linear actuator having a moving end joined, directly or indirectly, to the second slide structure for translating the first and second slide structures along the azimuthal axis such that translational movement of the slide structures cause tilting of the at least one receiver about the tilt axis while still allowing rotational motion of the at least one receiver and first slide structure about the azimuthal axis relative to the second slide structure;
(k) a rotational actuator for rotating the shaft such that the at least one receiver is capable of rotary motion about the azimuthal axes; and
(l) at least one controller for controlling the actuators to provide rotation of the at least one receiver about the azimuthal axis and tilting of the at least one receiver about the tilt axis.

2. The apparatus of claim 1 wherein the at least one receiver support structure further supports, directly or indirectly, an antenna for transmitting an interrogation signal that can be either reflected from the remote source to provide a return signal or otherwise can generate a return signal from the remote source capable of being received by the at least one receiver.

3. The apparatus of claim 2 wherein the antenna concentrates the return signal on to the at least one receiver.

4. The apparatus of claim 3 wherein the antenna comprises a radar antenna, the interrogation signal comprises a radar signal, the return signal comprises a reflected signal, and the receiver send collected signals down a waveguide to a detector that has a fixed position relative to the base.

5. The apparatus of claim 1 wherein the receiver comprises a receiver selected from the group consisting of (I) a thermal (IR) camera and (II) an acoustic listening device.

6. The apparatus of claim 1 wherein the azimuthal axis has a variable orientation with respect to a zenith, due at least in part, to rocking movement that the base can undergo when the apparatus is in use.

7. The apparatus of claim 1 wherein the base comprises a buoyant structure that floats on a body of water.

8. A movement and stabilization system for supporting at least one directionally sensitive receiver is mounted indirectly to a base that is subject to angular oscillation or rocking about two perpendicular axes that are each perpendicular to a vertical axis pointing to a zenith around which rotation is to occur, comprising:
(a) a base;
(b) at least one signal receiver that passes signals to at least one detector wherein the at least one signal receiver can be orientated in different directions to obtain signals emanating from one or more remote sources;
(c) a receiver support structure attached, directly or indirectly, to the base;
(d) a rotatable shaft extending, directly or indirectly, from the support structure along an azimuthal axis around which the at least one detector can rotate wherein the azimuthal axis has a fixed orientation with respect to the base, and wherein the azimuthal axis has a variable orientation with respect to a zenith, due at least in part, to rocking movement that the base can undergo when the apparatus is in use;
(e) at least one crank arm fixedly connected directly or indirectly to the at least one receiver wherein the at least one crank arm extends, directly or indirectly, away from a rear of the at least one receiver and comprises at least one tilt axis engagement feature, wherein the tilt axis is, directly or indirectly, supported by the shaft and extends perpendicular to the azimuthal axis and allows pitch movement, and further includes at least one connector arm engagement feature;
(f) a connector arm joining, directly or indirectly, the at least one connector arm engagement feature in a manner that allows rotational motion between the at least one connector arm and the at least one crank arm wherein the rotational motion occurs about an axis that is parallel to the tilt axis;
(g) a first slide structure capable of translational movement along the azimuthal axis, wherein the slide structure connects directly or indirectly to a lower end of the at least one connector arm in a manner that allows rotation of the at least one connector arm and such that translation of the slide structure causes motion of the at least one connector arm, the at least one crank arm, and tilting of the at least one receiver;
(h) a second slide structure capable of translational movement along the azimuthal axis;
(i) a bearing having first and second mounting features that can be rotated relative to each other about the azimuthal axis wherein the first mounting feature is fixedly, directly or indirectly, connected to the first slide structure and wherein the second mounting feature is fixedly, directly or indirectly connected to the second slide structure;
(j) at least one linear actuator having a moving end joined, directly or indirectly, to the second slide structure for translating the first and second slide structures along the azimuthal axis such that translational movement of the slide structures cause tilting of the at least one receiver about the tilt axis while still allowing rotational motion of the at least one receiver and first slide structure about the azimuthal axis relative to the second slide structure;
(k) a rotational actuator for rotating the shaft such that the at least one receiver is capable of rotary motion about the azimuthal axes; and
(l) at least one controller for rotating the at least one receiver about the azimuthal axis and to tilt the at least one receiver about the tilt axis such that any rocking of the base is compensated for such that rotation about the azimuthal axis and tiling of at least one receiver about the tilt axis provide a directional sweeping with an angle of motion that is a selected angle of motion with a variation that is less than a variation of an angle of motion of the base.

9. The apparatus of claim 8 wherein the at least one receiver support structure further supports, directly or indirectly, an antenna for transmitting an interrogation signal that can be either reflected from the remote source to provide a return signal or otherwise can generate a return signal from the remote source capable of being received by the at least one receiver.

10. The apparatus of claim 9 wherein the antenna comprises a radar antenna, the interrogation signal comprises a radar signal, the return signal comprises a reflected signal, and the receiver send collected signals down a waveguide to a detector that has a fixed position relative to the base.

11. The apparatus of claim 8 wherein the receiver comprises a receiver selected from the group consisting of (I) a thermal (IR) camera and (II) an acoustic listening device.

12. The system of claim 8 wherein the selected angle of motion can be varied upon command.

13. The system of claim 8 wherein the variation in the angle of motion comprises an angle of motion selected from the group consisting of: (i) less than ¼ that of the base, (ii) less than ⅛ that of the base, (iii) less than 1/16 that of the base, (iv) less than 1/32 that of the base.

14. The system of claim 8 wherein the variation in the angle of motion is selected from the group consisting of: (i) less than 4° degrees, (ii) less than 2°, (iii) less than 1°, and (iv) less than ½°.

15. The system of claim 8 wherein the variation in the angle of motion is selected from the group consisting of: (i) smaller than 4° of positioning error when the a base motion orients the shaft at no more than 15° from vertical and a targeting direction is within an operational range of antenna orientation, (ii) smaller than 2° of positioning error when a base motion orients the shaft at no more than 15° from vertical and a targeting direction is within an operational range of antenna orientation, (iii) smaller than 1° of positioning error when the when a base motion orients the shaft at no more than 15° from vertical and a targeting direction is within an operational range of antenna orientation, (iv) smaller than ½° of positioning error when a base motion orients the shaft at no more than 15° from vertical and the targeting direction is within an operational range of antenna orientation. (v) smaller than 4° of positioning error when the a base motion orients the shaft at no more than 30° from vertical and a targeting direction is within an operational range of antenna orientation, (vi) smaller than 2° of positioning error when the a base motion orients the shaft at no more than 30° from vertical and a targeting direction is within an operational range of antenna orientation, (vii) smaller than 1° of positioning error when the a base motion orients the shaft at no more than 30° from vertical and a targeting direction is within an operational range of antenna orientation, and (ix) smaller than ½° of positioning error when the a base motion orients the shaft at no more than 30° from vertical and a targeting direction is within an operational range of antenna orientation.

16. The system of claim 8 wherein the base is mounted, directly or indirectly, to a buoyant structure comprising a floating buoy or platform.

17. The system of claim 8 wherein the at least one linear actuator can provide an acceleration of moving components at an amount selected from the group consisting of: (i) at least 2 m/s². (ii) at least 5 m/s², (iii) at least 10 m/s², and (iv) at least 20 m/s².

18. The system of claim 8 as they depend directly or indirectly from claim G104 wherein the antenna comprises a dish antenna.

19. The system of claim 8 wherein the controller provides motion commands to the linear and rotational actuators in response, at least in part, to differences between pointing direction of the antenna and an intended pointing direction of the antenna that is required to maintain the motion of the antenna on a preset sweeping path that is defined relative to fixed inertial coordinates.

20. A movement and stabilization system for supporting at least one directionally sensitive receiver, comprising:
(a) a base;
(b) at least one signal receiver that passes signals to at least one detector wherein the at least one signal receiver can be orientated in different directions to obtain signals emanating from one or more remote sources;
(c) a receiver support structure attached, directly or indirectly, to the base;
(d) a rotatable shaft extending, directly or indirectly, from the support structure along an azimuthal axis around which the at least one receiver can rotate wherein the azimuthal axis has a fixed orientation with respect to the base, and wherein the azimuthal axis has, at least at times, a non-parallel orientation with respect to a vertical axis that points to a zenith;
(e) at least one crank arm fixedly connected directly or indirectly to the at least one receiver wherein the at least one crank arm extends, directly or indirectly, away from a rear of the at least one receiver and comprises at least one tilt axis engagement feature, wherein the tilt axis is, directly or indirectly, supported by the shaft and extends perpendicular to the azimuthal axis and allows pitch movement, and further includes at least one connector arm engagement feature;
(f) a connector arm joining, directly or indirectly, the at least one connector arm engagement feature in a manner that allows rotational motion between the at least one connector arm and the at least one crank arm wherein the rotational motion occurs about an axis that is parallel to the tilt axis;
(g) a first slide structure capable of translational movement along the azimuthal axis, wherein the slide structure connects directly or indirectly to a lower end of the at least one connector arm in a manner that allows rotation of the at least one connector arm and such that translation of the slide structure causes motion of the at least one connector arm, the at least one crank arm, and tilting of the at least one receiver;
(h) a second slide structure capable of translational movement along the azimuthal axis;
(i) a bearing having first and second mounting features that can be rotated relative to each other about the azimuthal axis wherein the first mounting feature is fixedly, directly or indirectly, connected to the first slide structure and wherein the second mounting feature is fixedly, directly or indirectly connected to the second slide structure;
(j) at least one linear actuator having a moving end joined, directly or indirectly, to the second slide structure for translating the first and second slide structures along the azimuthal axis such that translational movement of the slide structures cause tilting of the at least one receiver about the tilt axis while still allowing rotational motion of the at least one receiver and first slide structure about the azimuthal axis relative to the second slide structure;
(k) a rotational actuator for rotating the shaft such that the at least one receiver is capable of rotary motion about the azimuthal axes; and
(l) at least one controller for controlling the actuators to provide for rotating the at least one receiver about the azimuthal axis and for tilting the at least one receiver about the tilt axis such that any difference in orientation between the azimuthal axis and the vertical axis is greater than a misorientation between a sweeping path of the at least one receiver and a preset sweeping path of the at least one receiver relative to the vertical axis.
